(19) United States
(12) Patent Application Publication
(10) Pub. No.: US 2017/0071695 A1
(43) Pub. Date: Mar. 16, 2017

(54) MEDICAL LASER LIGHT SOURCE SYSTEM

(71) Applicants: RIKEN, Saitama (JP); NATIONAL UNIVERSITY CORPORATION TOKYO MEDICAL AND, Tokyo (JP)

(72) Inventors: Sadahiro NAKAJIMA, Yamanashi (JP); Keigo NAGASAKA, Gunma (JP); Akira AOKI, Chiba (JP); Norihito SAITO, Saitama (JP); Masaki YUMOTO, Ibaraki (JP); Satoshi WADA, Saitama (JP); Yuichi IZUMI, Tokyo (JP)

(21) Appl. No.: 15/109,819

(22) PCT Filed: Jan. 8, 2015
(86) PCT No.: PCT/JP2015/050393

§ 371 Date: Oct. 3, 2016

(30) Foreign Application Priority Data
Jan. 10, 2014 (JP) 2014-003591

(51) Int. Cl. A61C 1/00; H01S 3/16; H01S 3/067; H01S 3/094

(52) U.S. Cl. CPC A61C 1/0046; A61C 1/0061; H01S 3/094053; H01S 3/094096; H01S 3/1628; H01S 3/162; H01S 3/1623; H01S 3/1621; H01S 3/06708

(57) ABSTRACT

A medical laser light source system including an excitation laser light source apparatus that generates first excitation light having a wavelength greater than or equal to 1.5 μm and less than or equal to 2.2 μm and second excitation light having a wavelength greater than or equal to 1.5 μm and less than or equal to 2.2 μm and differing from the first excitation light with respect to at least one of oscillation energy intensity, oscillation pulse width, repeating frequency, and peak power; an optical fiber that is long-distance and propagates the first excitation light and the second excitation light generated by the excitation laser light source apparatus; and a laser device that generates laser light having a wavelength of at least 2.7 μm and no greater than 3.2 μm, using at least one of the first excitation light and the second excitation light emitted from the optical fiber.

### BACKGROUND

1. Technical Field

The present invention relates to a medical laser light source system.

2. Related Art

Since the development of an Er:YAG laser with a wavelength of 2.94 μm using flash lamp excitation was announced in 1988 (see Non-Patent Document 1), research results relating to medical lasers have been collected and were published in January, 2012 (see Non-Patent Document 2).

The U.S. company Syneron Medical Ltd. has developed a dental treatment product that incorporates a miniature flash lamp excitation Er pulse laser oscillator in a dental handpiece (see Non-Patent Document 4). Jorg Meister et al. from the U.S. have announced transmission of a semiconductor laser by quartz fiber and excitation of an Er laser resonator incorporated in a dental handpiece (see Non-Patent Document 5).

Furthermore, proposals have been made for a light guide apparatus in which is mounted a specialized optical fiber propagating a laser with a wavelength of 2.94 μm (see Patent Document 1 and Patent Document 2), protecting this optical fiber with dry air (see Patent Document 3), a protective structure for this optical fiber made of a metal flexible tube (see Non-Patent Document 3), and the like.

Furthermore, the Slovenian company Fotona is developing a dental treatment product using a flash lamp excitation Er pulse laser (see Non-Patent Document 6). Furthermore, a proposal has been made for a medical laser that improves the sterilization effect by performing oscillation with a high peak power, high repetition rate, and low pulse energy (see Non-Patent Document 7). Yet further, a laser medium is being developed that is capable of laser oscillation between approximately 2110 nm and approximately 2840 nm (see Patent Document 4).
Patent Document 1: Japanese Patent Application Publication No. H7-51285
Patent Document 2: Japanese Patent Application Publication No. 2006-254986
Patent Document 3: Japanese Patent Application Publication No. H7-51287
Patent Document 4: Japanese Patent Application Publication No. 2005-504437
Non-Patent Document 1: Sadahiro NAKAJIMA et al., “Development and Application of High Power 3 μm Er:YAG laser,” The Japan Society for Applied Physics, 1988, 4aR-9
Non-Patent Document 2: Akira Aoki et al., “Use of Er:YAG Lasers for Periodontal Treatment and Implant Treatment,” Igaku Jouhou-sha, Ltd.
Non-Patent Document 3: Biolase Inc., “Flash Lamp Excitation Er:YSGG Pulse Laser dental Treatment Device,” [online], [search date Dec. 26, 2013]

Internet URL: <http://www.biolase.com/Pages/Dental-Lasers.aspx>
Non-Patent Document 4: Syneron Ltd., “Er Pulse Laser Dental Treatment Device,” [online], [search date Dec. 26, 2013],

Internet URL: <http://www.synerondental.com/why-laser>
Non-Patent Document 5: Jorg Meister et al., “Multireflection Pumping Concept for Miniaturized Diode-Pumped Solid-State Lasers,” November 2004, Applied Optics/V43, No. 31
Non-Patent Document 6: Fotona (Slovenia), [online], [search date Dec. 26, 2013]

Internet URL: <http://www.fotona.comkn/products/1188/lightwalked>
Non-Patent Document 7: Hiroyasu YAMAGUCHI et al., “Effects of Irradiation of an Erbium:YAG Laser on Root Surfaces,” December 1997, J. PERIDONTOL/V68, No. 12

### SUMMARY

In the medical field, it has been difficult to use a laser that is a composite of different types of laser light sources that each have different usage methods.

According to a first aspect of the present invention, provided is a medical laser light source system comprising an excitation laser light source apparatus that generates first excitation light having a wavelength greater than or equal to 1.5 μm and less than or equal to 2.2 μm and second excitation light having a wavelength greater than or equal to 1.5 μm and less than or equal to 2.2 μm and differing from the first excitation light with respect to at least one of oscillation energy intensity, oscillation pulse width, repeating frequency, and peak power; an optical fiber that is long-distance and propagates the first excitation light and the second excitation light generated by the excitation laser light source apparatus; and a laser device that generates laser light having a wavelength greater than or equal to 2.7 μm and less than or equal to 3.2 μm, using at least one of the first excitation light and the second excitation light emitted from the optical fiber.

The summary clause does not necessarily describe all necessary features of the embodiments of the present invention. The present invention may also be a sub-combination of the features described above.

### BRIEF DESCRIPTION OF THE DRAWINGS

FIG. 1 shows an exemplary configuration of a medical laser light source system 10.

FIG. 2 shows a configuration of the medical laser light source system 10 including the treatment table 50.

FIG. 3 is a cross-sectional view of the dental handpiece 500.

FIG. 4 shows the relationship between the coupler section 350 and the dental handpiece 500.

FIG. 5 is a cross-sectional view of another structure of the miniature 2.9 μm band laser device 40.

FIG. 6 shows another arrangement state of the miniature 2.9 μm band laser device 40.

FIG. 7 shows another arrangement state of the miniature 2.9 μm band laser device 40.

FIG. 8 shows another arrangement state of the miniature 2.9 μm band laser device 40.

FIG. 9 shows an exemplary configuration of another medical laser light source system 10.

FIG. 10 shows another configuration of the medical laser light source system 10 including the treatment table 50.

FIG. 11 shows an exemplary configuration of another medical laser light source system 10.

FIG. 12 shows a configuration of a medical laser light source system 10 including a plurality of treatment tables.

FIG. 13 shows the structure of a MOFA excitation laser light oscillator 211.

FIG. 14 shows another structure of a MOFA excitation laser light oscillator 211.

FIG. 15 shows another structure of a MOFA excitation laser light oscillator 211.

FIG. 16 shows the structure of a fiber laser excitation laser light oscillator 211.

FIG. 17 shows another structure of a fiber laser excitation laser light oscillator 211.

FIG. 18 shows exemplary controlled waveforms of the excitation laser light oscillator 211 shown in FIG. 17.

FIG. 19 shows exemplary controlled waveforms of the excitation laser light oscillator 211 shown in FIG. 17.

FIG. 20 shows a structure of the OC mirror 430.

FIG. 21 shows a structure of the OC mirror 430.

FIG. 22 is a graph showing the absorption spectrum of water.

FIG. 23 is a drawing for describing a combination of excitation laser light oscillators 211.

FIG. 24 is a drawing for describing a combination of excitation laser light oscillators 211.

FIG. 25 shows a configuration of a medical laser light source system including a treatment table 50a.

FIG. 26 is a cross-sectional view of another dental handpiece 500.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

### First Embodiment Example

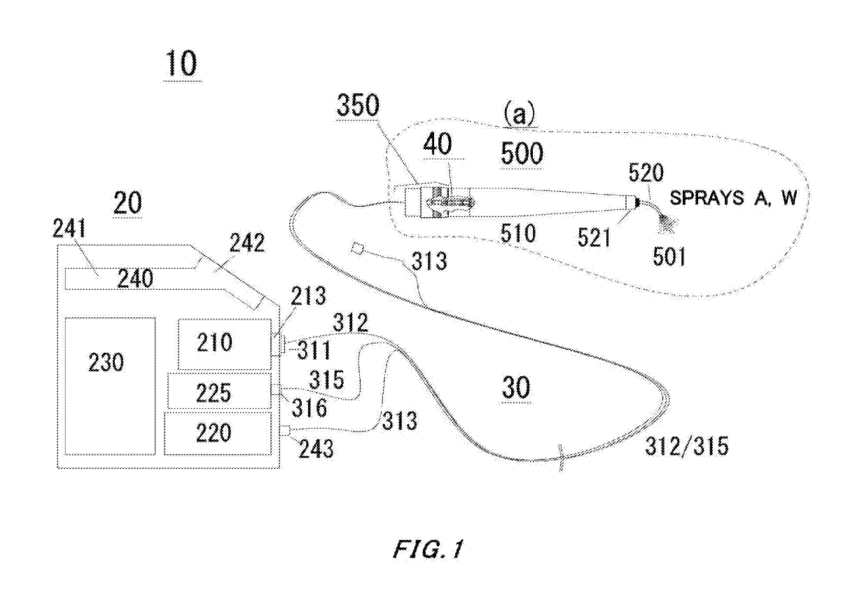

FIG. 1 shows an exemplary configuration of a medical laser light source system 10. The medical laser light source system 10 includes an excitation laser light source apparatus 20, a long-distance fiber light guide apparatus 30, and a dental handpiece 500.

The excitation laser light source apparatus 20 includes component units such as an excitation laser light source unit 210, a cooling unit 220, a spray control unit 225, a power supply unit 230, and a control display unit 240.

A focusing unit 213 is attached to an emission opening of the excitation laser light source unit 210. The focusing unit 213 focuses an excitation laser light 212 emitted from an excitation laser light oscillator 211 on an excitation light entrance opening 311 of the long-distance fiber light guide apparatus 30. The long-distance fiber light guide apparatus 30 is attached in a freely attachable and detachable manner to the emission opening of the focusing unit 213.

The cooling unit 220 cools the heat generated by the excitation laser light source unit 210. For example, an oscillation efficiency of 20% is realized for the excitation laser light source unit 210 set to have a maximum average output of 20 W, and therefore the cooling unit 220 being mounted has a cooling capability of approximately 100 W.

The spray control unit 225 includes a water tank for storing spray water W, a small pump for supplying the spray water W from the water tank, and a compressor for supplying spray air A. The spray control unit 225 uses electromagnetic valves to adjust the flow rate of each of the spray water W and the spray air A. The spray water W and the spray air A are guided to the coupler section 350 from a terminal 316, through the long-distance fiber light guide apparatus 30. The terminal 316 of the long-distance fiber light guide apparatus 30 is attached in a freely attachable and detachable manner to the spray control unit 225.

The spray control unit 225 controls the mixture amount of the spray water W and the spray air A, the flow rate of the spray water W, and the flow rate of the spray air A. In this way, the spray water W and the spray air A are discharged from the irradiation tip 520 attached to the dental handpiece 500 toward an affected part. Therefore, unnecessary heat and ablation materials occurring when the affected part is irradiated with the laser treatment light 501 having a 2.9 μm band are removed.

The power supply unit 230 supplies the power that is necessary for driving each configurational unit. The control display unit 240 includes a main controller 241 and a display panel 242.

The main controller 241 has a storage section such as a ROM or RAM and a computational processing section such as a CPU mounted thereon. Performance-related data, control programs, and the like for the laser treatment light 501 having the 2.9 μm band emitted from the tip of the dental handpiece 500 and for an excitation laser light 212 measured in advance are recorded in the storage section. A CPU or the like for controlling the power supply unit 230 and the excitation laser light source unit 210 based on the data in the storage section and safely outputting the 2.9 μm band laser treatment light 501 according to settings made in the control console 250 by an operator is mounted in the computational processing section.

Flow rate control data and control programs for the spray water W and spray air A of the spray control unit 225 are also stored in the storage section. In this way, by having the computational processing section control the cooling unit 220 and the spray control unit 225, the main controller 241 controls the cooling of equipment and the discharge of the sprays. The display panel 242 displays current setting values of the laser output, the usage state of the dental handpiece 500, the operational state of each unit forming the medical laser light source system 10, and the like.

The long-distance fiber light guide apparatus 30 includes a quartz fiber cord 312 with a low OH ion concentration less than or equal to 10 ppm. Therefore, the excitation light with an excitation wavelength range of 1.5 μm to 2.2 μm used for the laser medium 410 is transmitted with low loss. An SB series step index type of quartz fiber cord 312 with a core diameter of 400 μm, manufactured by Fujikura Ltd., can be used as the quartz fiber cord 312. This optical fiber cord includes a first cover made of a silicon resin and a second cover made of polyamide, and also includes a tension member made of aramid fiber and an outer skin made of PVC around these covers. In this way, the long-distance fiber light guide apparatus 30 can be formed to be strong against external force, such as a compression force, and have excellent flexibility.

Quartz fiber cords 312 having similar structures are produced by many fiber manufacturers, and these quartz fiber cords can also be used. A graded-index optical fiber can also be used for the long-distance fiber light guide apparatus 30. An FC fiber connector can be used for the excitation light entrance opening 311 of the long-distance fiber light guide apparatus 30, but other types of connectors can be used instead.

A forward portion of the long-distance fiber light guide apparatus 30 is arranged in the treatment table 50. The coupler section 350 is arranged at the forward end of the long-distance fiber light guide apparatus 30. A miniature 2.9 μm band laser device 40 may be housed within the coupler section 350.

The dental handpiece 500 is used at the treatment table 50. The dental handpiece 500 is attached in an attachable and detachable manner to the coupler section 350, and is used by being gripped by hand when the operator is treating the affected part.

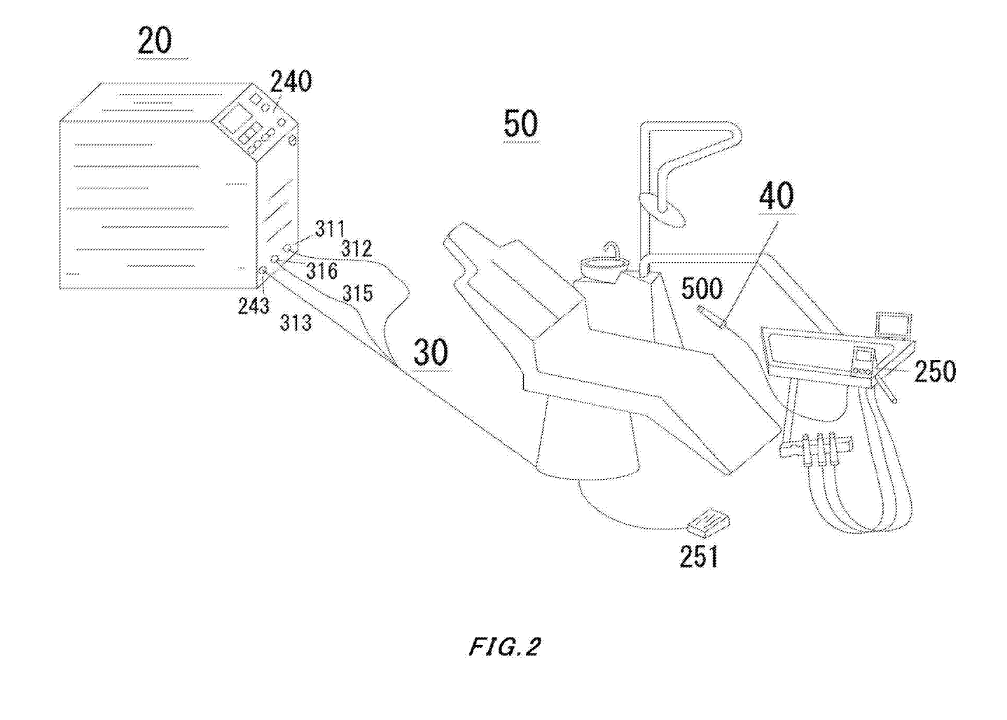

FIG. 2 shows a configuration of the medical laser light source system 10 including the treatment table 50. As shown in the drawing, a control console 250 and a foot switch 251 are arranged in the treatment table 50.

The control console 250 includes various switches, a display for displaying the settings, and the like. Therefore, a user can set the output of the 2.9 μm band laser treatment light 501, the sprays, and the like.

The control console 250 is connected to the control display unit 240 incorporated in the excitation laser light source apparatus 20, by a communication electrical cord 313, and transfers control signals via this communication electrical cord 313. The communication electrical cord 313 may be housed in the long-distance fiber light guide apparatus 30. The ends of the communication electrical cord 313 are respectively connected to an electric terminal 243 of the excitation laser light source apparatus 20 and an electric terminal of the control console 250.

The foot switch 251 is manipulated by the operator as a switch for outputting the 2.9 μm band laser treatment light 501. A control power line of the foot switch 251 may be connected to the control console 250.

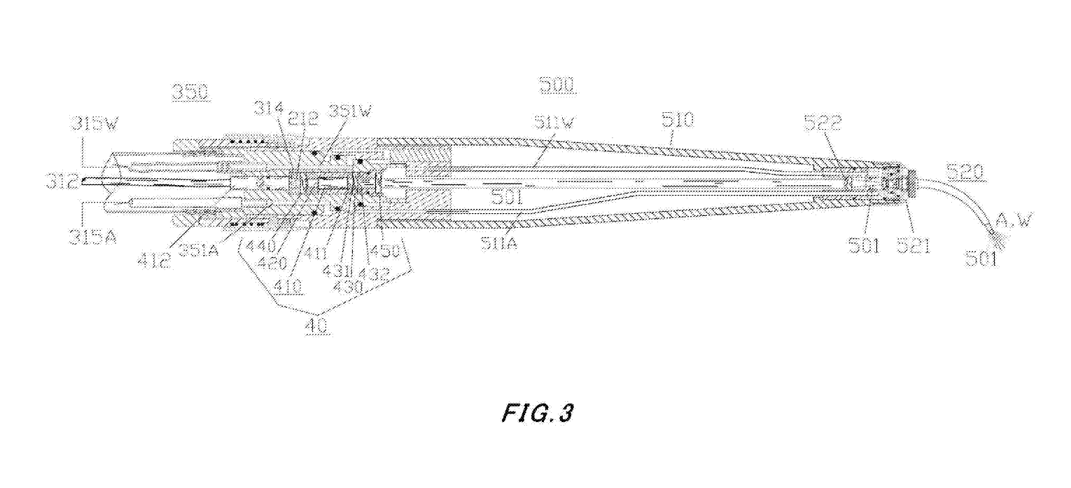

FIG. 3 is a cross-sectional view of the coupler section 350 and the dental handpiece 500. The coupler section 350 houses the quartz fiber cord 312, tube paths 315W and 315A, and the miniature 2.9 μm band laser device 40. The dental handpiece 500 includes outer-cylinder inner-tube paths 511A and 511W, an irradiation tip 520, a tip connection terminal 521, and a focusing element 522.

A tip connection terminal 521 is provided on the tip of the dental handpiece 500. The irradiation tip 520 for irradiating the affected part with the 2.9 μm band laser treatment light 501 is attached in an attachable and detachable manner to the tip connection terminal 521.

The focusing element 522 that focuses the 2.9 μm band laser treatment light 501 at the irradiation tip 520 and the outer-cylinder inner-tube paths 511A and 511W that guide the spray water W and spray air A supplied via the coupler section 350 to the irradiation tip 520 are provided inside the dental handpiece 500. The spray air A flows inside the outer-cylinder inner-tube path 511A and the spray water W flows in the outer-cylinder inner-tube path 511W.

The spray water W and the spray air A are guided through the tube path 315W and the tube path 315A housed in the long-distance fiber light guide apparatus 30 to the intra-coupler tube paths 351A and 351W of the coupler section 350, and further guided to the irradiation tip 520 through the outer-cylinder inner-tube paths 511A and 511W provided within the dental handpiece 500. Furthermore, the spray water W and the spray air A are sprayed from the tip of the irradiation tip 520 toward the irradiation position. The flow rates of the spray water W and spray air A may be set manually by the operator via the control console 250, or may be preset.

The spray water W and the spray air A can be supplied under the control of the spray control unit 225, by a water tank, a miniature pump that supplies the spray water W, and a compressor that supplies the spray air A, which are provided in the excitation laser light source apparatus 20. If a water tank, miniature pump, and compressor are already present in a medical facility, external high-pressure water and air for a dental drill may be used. Furthermore, in the example described above, a cooling effect is also achieved for the laser medium 410 by providing the intra-coupler tube path 351W, which is the flow path for the spray water W of the coupler section 350, to the side of the laser medium 410.

The miniature 2.9 μm band laser device 40 is mounted within the coupler section 350, and includes a laser medium 410, a ferrule 412, an HR mirror 420, an OC mirror 430, and an excitation light focusing unit 440.

The miniature 2.9 μm band laser device 40 includes the laser medium 410 doped with Cr²⁺ ions in a manner to absorb at least 95% of light with a wavelength of 1.78 on a ZnSe group II-VI semiconductor with a size of 3 mm (depth)×3 mm (height)×10 mm (length).

The HR mirror 420 is formed on the back end surface of the laser medium 410 and the double reflection prevention film 411 is formed on the front end surface of the laser medium 410. The HR mirror 420 is highly transparent (at least 80% transparent in this embodiment) with respect to the 1.78 μm wavelength of the excitation laser light 212 and highly reflective (at least 99% reflective in this embodiment) with respect to the 2.9 μm band laser treatment light 501. The double reflection prevention film 411 respectively transparently passes at least 80% and at least 99% of the 1.78 μm light and the 2.9 μm band laser treatment light 501.

An OC film 431 is formed on the back end surface of the OC mirror 430 that draws out the 2.9 μm band laser treatment light 501, and an antireflection film 432 is formed on the front end surface of the OC mirror 430. The OC film 431 is highly reflective (at least 80% reflective in this embodiment) with respect to the 1.78 μm wavelength, which is the excitation wavelength of the excitation laser light 212, and transparently passes a portion (40% in this embodiment) of the 2.9 μm band laser treatment light 501. The antireflection film 432 transparently passes at least 99% of the 2.9 μm band laser treatment light 501. A resonator is formed by the OC mirror 430 and the HR mirror 420.

A ferrule 412 is attached to the back end of the miniature 2.9 μm band laser device 40. The quartz fiber cord 312 is connected to the front end portion of the ferrule 412, and the excitation light emission opening 314 is formed in the back end portion of the ferrule 412.

In the miniature 2.9 μm band laser device 40, the excitation laser light 212 emitted from the excitation light emission opening 314 is collimated by the excitation light focusing unit 440 and focused on the laser medium 410 from behind the HR mirror 420. The excitation laser light 212 focused by the laser medium 410 excites the Cr²⁺ ions, thereby causing the 2.9 μm band laser treatment light 501 to be emitted from the OC mirror 430.

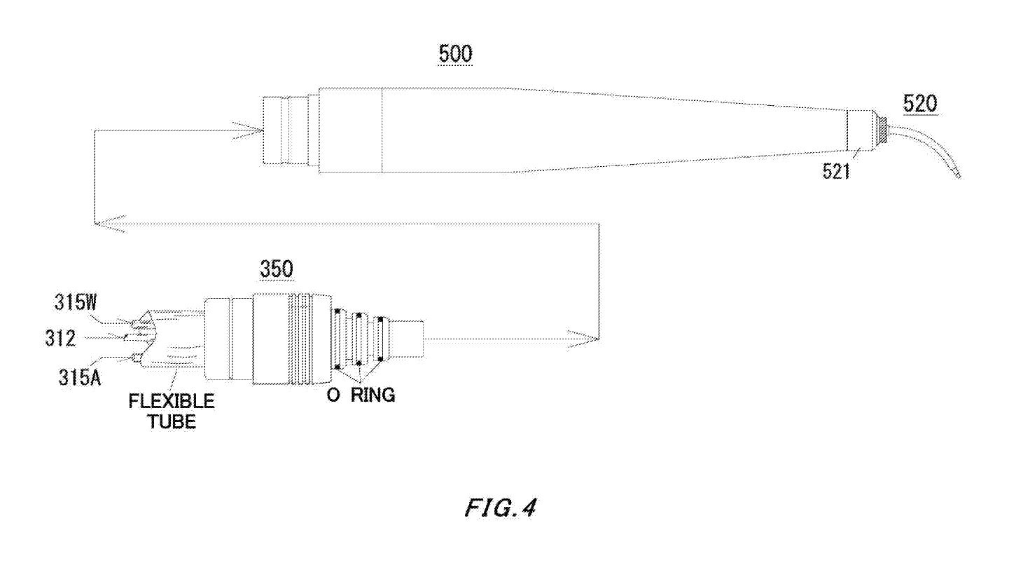

FIG. 4 shows the relationship between the coupler section 350 and the dental handpiece 500. As shown in the drawing, the dental handpiece 500 mounted in the medical laser light source system 10 and the coupler section 350 attached to the forward tip of the long-distance fiber light guide apparatus 30 are configured such that the dental handpiece 500 can be detached from and attached to the coupler section 350 with one touch. Furthermore, a variety of irradiation tips 520 can be detached from and attached to the dental handpiece 500 with one touch and replaced.

With the structure described above, the dental handpiece 500 and irradiation tip 520 that touch the affected part during each treatment can be separated from the coupler section 350, and therefore there is no need to sterilize the long-distance fiber light guide apparatus 30 that includes the coupler section 350 on which the miniature 2.9 μm band laser device 40 is mounted.

In the dental handpiece 500, the 2.9 μm band laser treatment light 501 emitted from the miniature 2.9 μm band laser device 40 is guided to the front of the dental handpiece 500 by the relay optical element 450, further focused by the focusing element 522 attached in the front end, and guided to the irradiation tip 520. In this manner, the 2.9 μm band laser treatment light 501 is emitted from the tip of the irradiation tip 520.

In the present embodiment, Cr²⁺:ZnSe can be used as the laser medium 410. This laser medium 410 can be excited with excitation light having a wavelength band from 1.5 μm to 2.2 μm, which can be transmitted long-distance by quartz fiber, and oscillate the 2.9 μm band laser treatment light 501. As other examples, a group II-VI semiconductor (ZnSe, ZnS, CdSe, CdTe, etc.) doped with transitional metal ions (Cr²⁺, Fe²⁺, Co²⁺, etc.) can be used as the laser medium 410.

The excitation laser light oscillator 211, which is comprised of a group II-VI semiconductor laser medium having a long medium length (>3 mm) manufactured by depositing the transitional metal and dispersing the transitional metal through annealing on a side surface of a rod or the like cut from a group II-VI semiconductor ingot manufactured by zone melting or the Bridgman method, is mounted on the medical laser light source system 10, and this configuration also enables the output of the laser energy necessary for treatment.

In the present embodiment, the intra-coupler tube path 351W that is the flow path of the spray water W of the coupler section 350 is provided to the side of the laser medium 410. Therefore, a cooling effect is realized for the laser medium 410 by the spray water W and spray air A.

When treating dental hard tissue at the treatment table 50 shown in FIG. 2, the excitation laser light source unit 210 supplies the laser medium 410 made of Cr²⁺:ZnSe used for the miniature 2.9 μm band laser device 40 with the excitation laser light obtained by strong pulse oscillation of a wavelength band of 1.5 μm to 2.2 μm, which is the excitation light wavelength region.

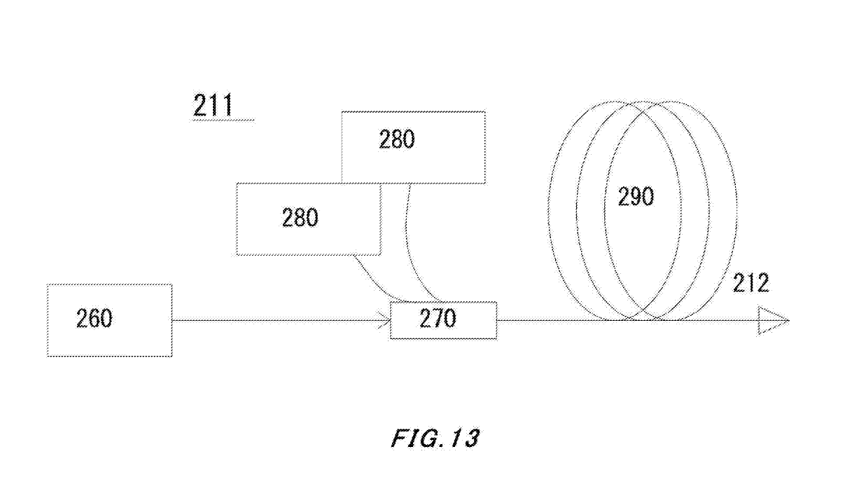

The MOFA (Master Oscillator and Fiber Amplifier) excitation laser light oscillator 211 shown in FIG. 13 can be mounted and used as the excitation laser light source unit 210. The excitation laser light oscillator 211 shown in FIG. 13 amplifies the distributed feedback (DFB) laser that oscillates at 1.74 μm, which is the peak excitation wavelength of Cr+2:ZnSe, as first-type light 260, using a Tm active fiber 290. In this way, the oscillation pulse width can be altered between 10 ns and 1000 μs, the oscillation energy intensity can be altered between 0.01 mJ and 2 J, and the repeating frequency can be altered between 1 Hz and 1 MHz. The excitation laser light source unit 210 is described further below with reference to FIG. 13.

Another laser light source can be used as the excitation laser light source unit 210. For example, a solid state laser such as a 2.0 μm band LD excitation Tm:YAG laser that can perform strong pulse oscillation at 1.5 μm to 2.2 μm or a laser that oscillates in the same wavelength region using OPO can be used. Furthermore, a flash lamp excitation solid state laser such as a Ho:YAG laser that oscillates at a 2.1 μm band or an Er:YAG laser that oscillates at a 1.7 μm band can be used for medical applications where a relatively low repeating frequency up to approximately 100 Hz is sufficient. Furthermore, it is obvious that another laser light source may be used.

By using the medical laser light source system 10 described above, when treating a dental hard tissue of enamel, for example, the 2.9 μm band laser treatment light 501 and mist can be emitted toward the enamel from the tip of the irradiation tip 520 and the irradiation portion can be ablated by stepping on the foot switch 251 after using the control console 250 to set the irradiation conditions of the 2.9 μm band laser treatment light 501 at an energy of 200 mJ, a pulse width of 50 μs, and a repeating frequency of 20 Hz (peak power with the same settings is 4 kW) and set the amounts of the spray water W and spray air A enabling formation of a suitable mist (e.g. 10 cc/min for the spray water W and 2 L/min for the spray air A).

After this, by using the control console 250 to set the irradiation conditions of the 2.9 μm band laser treatment light 501 at an energy of 3 mJ, a pulse width of 200 ns, and a repeating frequency of 10 Hz (peak power with the same settings is 15 kW) and set the amounts of the spray water W and spray air A enabling formation of a suitable mist (e.g. 10 cc/min for the spray water W and 2 L/min for the spray air A) and then stepping on the foot switch 251, processing can be applied to the ablation surface for adhesive repair performed later.

The sterilization of periodontal disease-causing toxins or the like in the mouth can be achieved by performing irradiation after setting the irradiation conditions to be at an energy of 0.4 mJ, a pulse width of 500 μs, and a repeating frequency of 25 kHz (peak power with the same settings is 0.8 kW) and setting the mist conditions (e.g. 0.5 cc/min for the spray water W and 1 L/min for the spray air A).

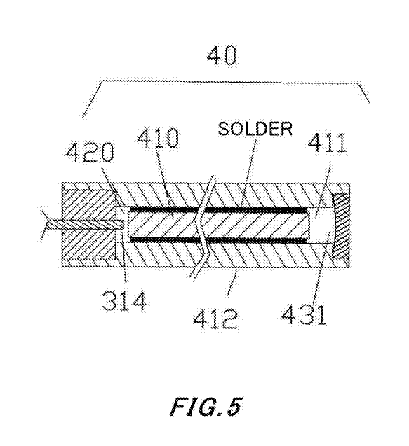

FIG. 5 is a cross-sectional view of another structure of the miniature 2.9 μm band laser device 40. In this miniature 2.9 μm band laser device 40, the HR mirror 420 is coated onto the back end surface and the double reflection prevention film 411 is coated onto the front end surface. Furthermore, the resonator may have a structure in which the laser medium 410 is fixed to the ferrule 412 by soldering, the excitation light emission opening 314 is provided in the back end surface of the ferrule 412, and the OC film 431 is provided on the front end portion of the ferrule 412. The excitation light emission opening 314 is arranged directly in front of the HR mirror 420.

In the miniature 2.9 μm band laser device 40 described above, the HR mirror 420 is highly transparent with respect to the excitation laser light 212 and highly reflective with respect to the 2.9 μm band laser treatment light 501. The double reflection prevention film 411 prevents reflection of the excitation laser light 212 and the 2.9 μm band laser treatment light 501. The laser medium 410 is formed in the shape of a fiber rod that is 0.5 mm×15 mm and coated with copper on the side surface. The OC film 431 reflects a large amount of the excitation laser light 212 and transparently passes a portion of the 2.9 μm band laser treatment light 501.

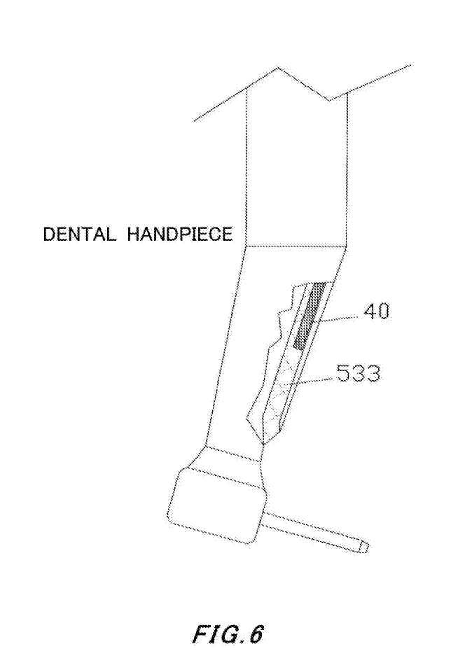

FIG. 6 shows another form of the dental handpiece 500. As shown in the drawing, the miniature 2.9 μm band laser device 40 may be provided to the light guide element 533 of the dental handpiece 500 described above and used for lighting and sterilization.

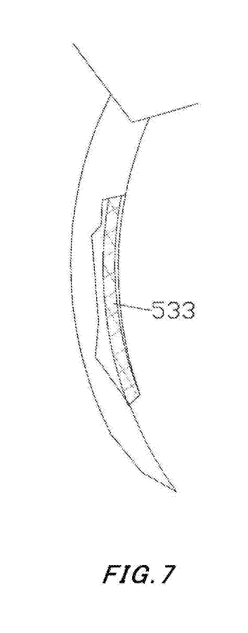

FIG. 7 shows yet another form of the dental handpiece 500. As shown in the drawing, the light guide element 533 of the 2.9 μm band laser treatment light 501 may be provided on a scaler tip portion. In this way, the laser can be used for lighting and sterilization in the scaler as well.

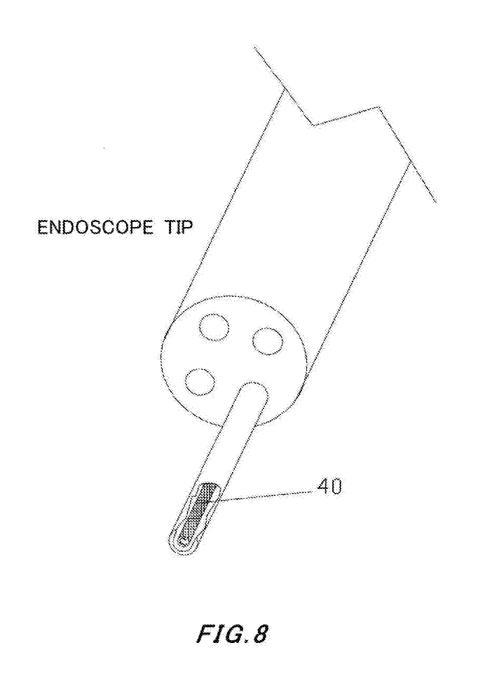

FIG. 8 shows yet another form of the dental handpiece 500. As shown in the drawing, the miniature 2.9 μm band laser device 40 may be attached to a tip of an endoscope. Therefore, a specialized transmission apparatus is unnecessary, and so ablation treatment and sterilization in the body can be performed using the 2.9 μm band laser treatment light 501.

### Second Embodiment Example

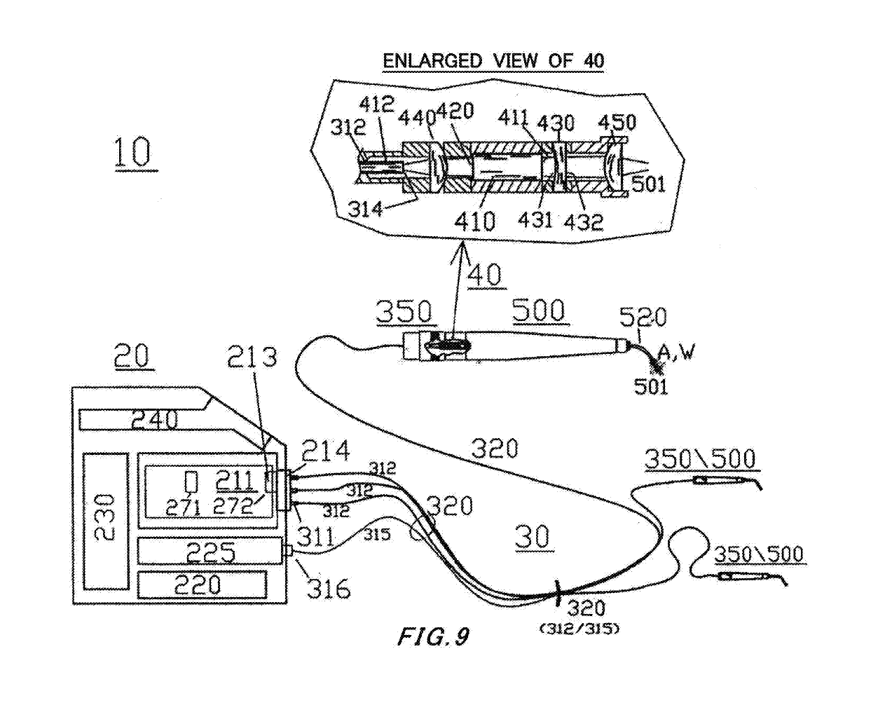

FIG. 9 shows an exemplary configuration of another medical laser light source system 10. The medical laser light source system 10 includes the excitation laser light source apparatus 20, the long-distance fiber light guide apparatus 30, and the dental handpiece 500.

This medical laser light source system 10 has the same structure as the medical laser light source system 10 of the first embodiment example, aside from the portions described below. Accordingly, identical components are given the same reference numerals and redundant descriptions are omitted.

In this medical laser light source system 10, the excitation laser light source apparatus 20 includes a light switching switch 214. The light switching switch 214 is mounted on the back end of the focusing unit 213 that focuses the excitation laser light 212 emitted by the excitation laser light oscillator 211 at the excitation light entrance opening 311 of the long-distance fiber light guide apparatus 30. Furthermore, a plurality of the long-distance fiber light guide apparatuses 30 are attached to the light switching switch 214, and the dental handpiece 500 is connected to the tip portion of each long-distance fiber light guide apparatus 30.

In the medical laser light source system 10 shown in the drawing, the miniature 2.9 μm band laser device 40 is arranged on the dental handpiece 500 side. The laser medium 410 used in this miniature 2.9 μm band laser device 40 has a size of 7 mm (depth)×7 mm (height)×7 mm (length). Furthermore, the laser medium 410 used here is a group II-VI semiconductor made of CdSe and doped with Cr²⁺ ions such that the absorption rate for light at a wavelength of 1.92 μm is greater than or equal to 60%.

The HR mirror 420 is formed on the back end surface of the laser medium 410, and the OC mirror 430 is formed on the front end surface of the laser medium 410. The HR mirror 420 is highly transparent (at least 85% transparent in this embodiment) with respect to the 1.92 μm wavelength of the excitation laser light 212 and highly reflective (at least 99.8% reflective in this embodiment) with respect to the 2.9 μm band laser treatment light 501. The OC mirror 430 is transparent (at least 85% transparent in this embodiment) with respect to the 1.92 μm wavelength and transparently passes a portion (20% in this embodiment) of the 2.9 μm band laser treatment light 501. A resonator is formed by the OC mirror 430 and the HR mirror 420.

The excitation laser light 212 emitted from the excitation light emission opening 314 is collimated into a beam with a large diameter by the excitation light focusing unit 440 and focused on the laser medium 410 from behind the HR mirror 420. The excitation laser light 212 focused on the laser medium 410 excites the Cr²⁺ ions, thereby causing the 2.9 μm band laser treatment light 501 to be emitted from the OC mirror 430.

Furthermore, the excitation laser light 212 with a wavelength of 1.92 μm that was not absorbed is also emitted from the dental handpiece 500 at the same time. The laser light obtained by mixing together the 2.9 μm band laser treatment light 501 and the excitation laser light 212 with a wavelength of 1.92 μm is guided by the relay optical element 450 to the irradiation tip 520 attached to the tip of the dental handpiece 500, and emitted from the tip of the irradiation tip 520 to irradiate the affected part. In this way, tooth tissue can also be treated. Accordingly, it is possible to realize excellent incision performance due to the synergy between the hemostatic effect realized by a suitable amount of the excitation laser light 212 with a wavelength of 1.92 μm being absorbed by living tissue and a high ablation effect realized by the 2.9 μm band laser treatment light 501 being absorbed quickly by the living tissue.

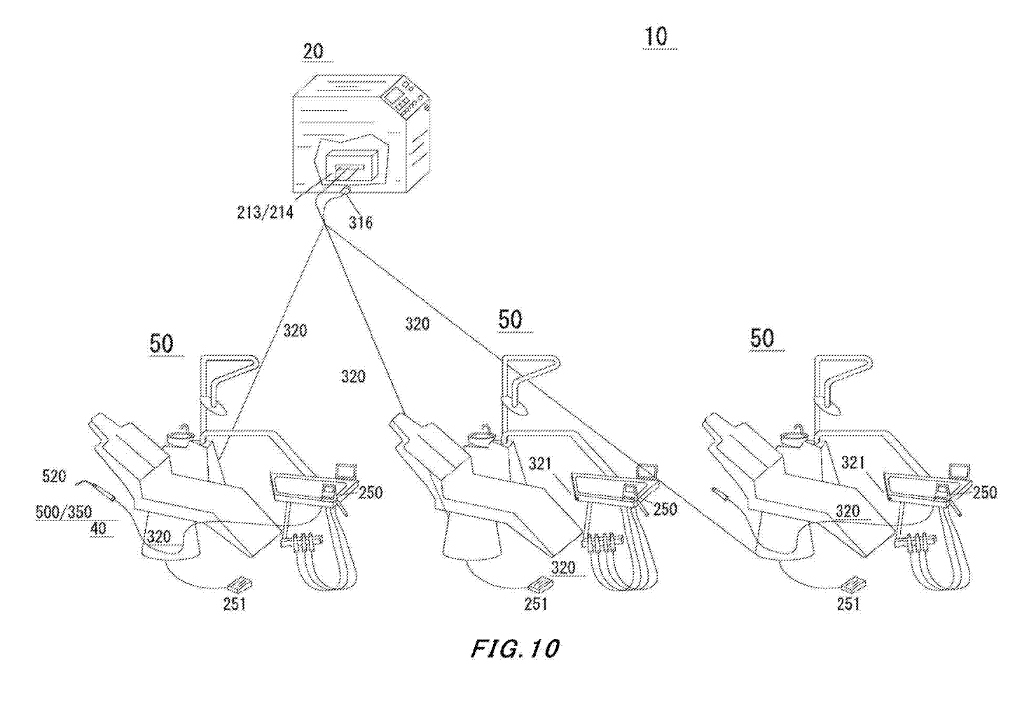

FIG. 10 shows a configuration of the medical laser light source system 10 including the treatment table 50. As shown in the drawing, the medical laser light source system 10 includes a plurality of treatment tables 50, and a control console 250 and foot switch 251 are provided for each treatment table 50. In this way, treatment using the 2.9 μm band laser treatment light 501 can be performed at each treatment table 50. Furthermore, with this medical laser light source system 10, it is possible to stop the supply of excitation light to a dental handpiece 500 that is not in use by switching the light switching switch 214.

In the medical laser light source system 10 shown in the drawing, Wifi (wireless LAN) communication can be performed between the control consoles 250 provided respectively to the treatment tables 50 and the control display unit 240 incorporated in the excitation laser light source apparatus 20. Therefore, the long-distance fiber light guide apparatus 30 houses the quartz fiber cord 312 and the tube paths 315A and 315W, but does not house the communication electrical cord 313.

In this way, the long-distance fiber light guide apparatus 30 is made smaller in diameter and lighter in weight while ensuring the transfer of control signals between the excitation laser light source apparatus 20 and each treatment table 50, thereby improving the handling of the dental handpiece 500. Furthermore, the cost can be reduced by reducing the number of components.

### Third Embodiment Example

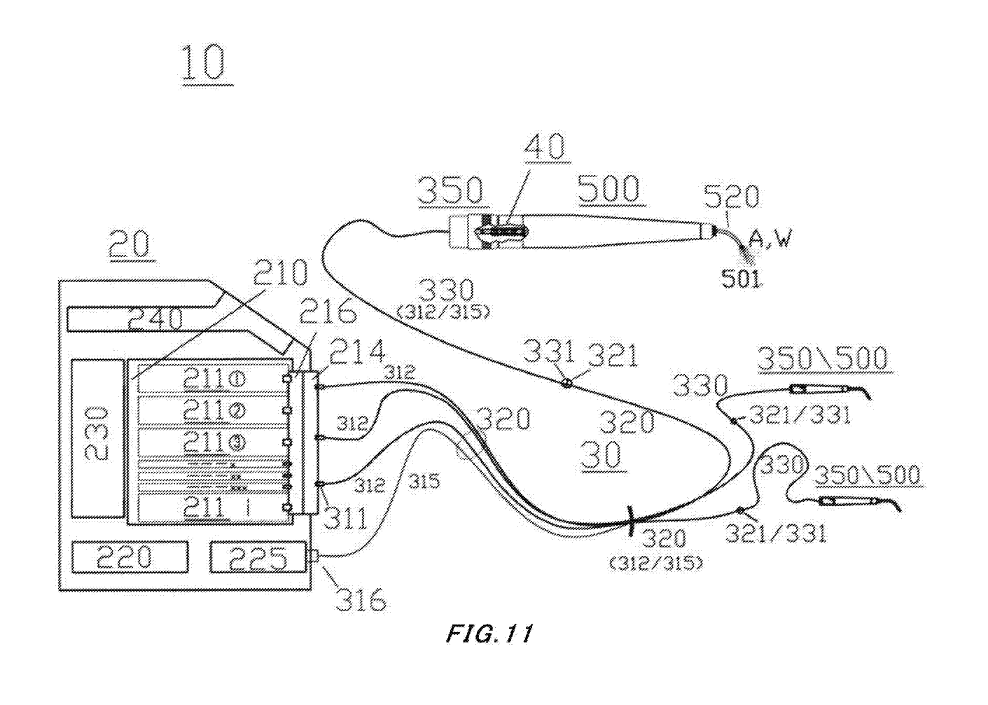

FIG. 11 shows an exemplary configuration of another medical laser light source system 10. The medical laser light source system 10 includes the excitation laser light source apparatus 20, the long-distance fiber light guide apparatus 30, and the dental handpiece 500.

This medical laser light source system 10 has the same structure as the medical laser light source system 10 of the first embodiment example, aside from the portions described below. Accordingly, identical components are given the same reference numerals and redundant descriptions are omitted.

In the medical laser light source system 10 shown in this drawing, the excitation laser light source apparatus 20 includes a plurality of excitation laser light oscillators 211. The outputs of the excitation laser light oscillators 211 are connected via a common photomixer 216 to the light switching switch 214 arranged downstream from the photomixer 216. Furthermore, a plurality of the long-distance fiber light guide apparatuses 30 are attached to the light switching switch 214, and a dental handpiece 500 is connected to the tip of each long-distance fiber light guide apparatus 30.

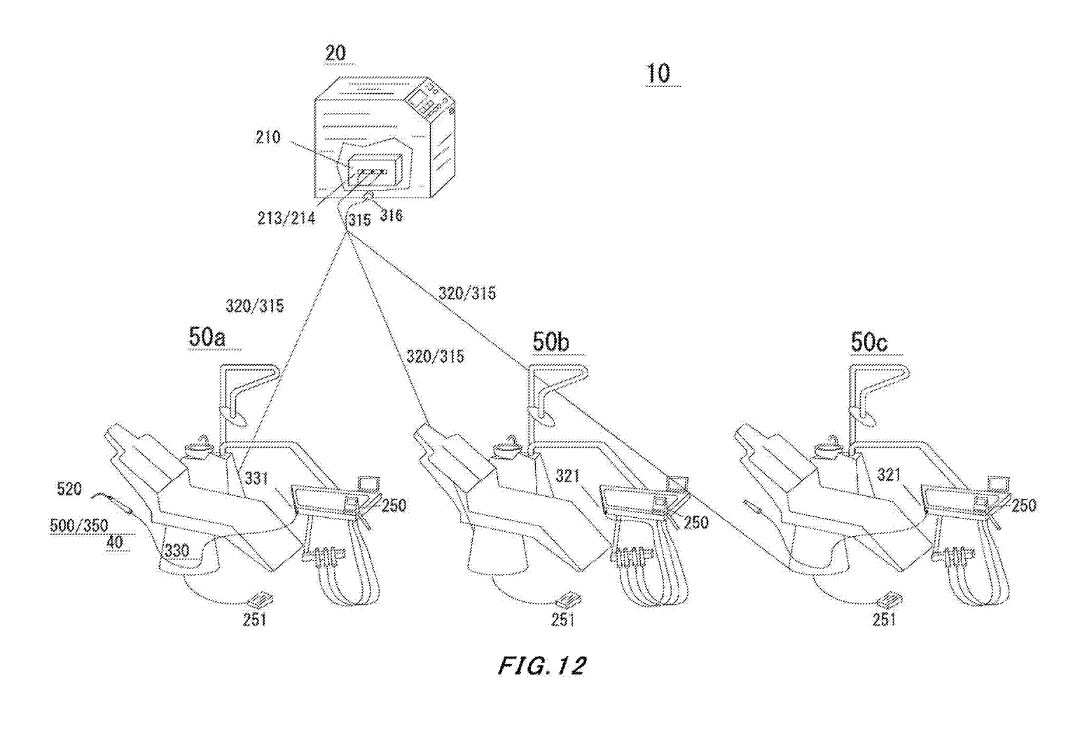

FIG. 12 shows a configuration of a medical laser light source system 10 including a plurality of treatment tables 50a, 50b, 50c. As shown in the drawing, the medical laser light source system 10 includes the plurality of treatment tables 50a, 50b, 50c. Each of the treatment tables 50a, 50b, 50c includes a control console 250 and a foot switch 251, and treatment using the 2.9 μm band laser treatment light 501 can be performed at each of the treatment tables 50.

Furthermore, in this medical laser light source system 10, by switching the light switching switch 214, it is possible to receive a supply of a different excitation light from one of the plurality of excitation laser light oscillators 211 arranged in the excitation laser light source apparatus 20. Accordingly, by attaching modules of all of the excitation laser light oscillators 211 that are optimal for each treatment to the excitation laser light source unit 210, it is possible to perform treatments for different treatment purposes respectively with the treatment tables 50a, 50b, 50c. Each module may be controlled through the control display unit 240.

Here, the excitation laser light source apparatus 20 in the medical laser light source system 10 shown in the drawing can be realized by forming a module from excitation laser light oscillators 211 that have an oscillation wavelength in a bandwidth from 1.5 μm to 2.2 μm and a variety of laser specifications that have different or can be caused to have different laser oscillation parameters such as the oscillation energy intensity, oscillation pulse width, repeating frequency, and peak power.

The excitation laser light oscillators 211 that have been formed as a module can be selected from a lineup prepared in advance, and one or more excitation laser light oscillators 211 can be implemented in the excitation laser light source unit 210. In other words, a structure may be used that enables incorporation through insertion according to the intended use by the user, such as in the manner of a memory board in a personal computer.

Furthermore, a plurality of different types of devices may be used as the dental handpiece 500 in the medical laser light source system 10 shown in this drawing. For example, a lineup may be made of various combinations of dental handpieces 500 that can emit one or more 2.9 μm band laser treatment lights 501 with suitably selected wavelengths in a range from 2.7 μm to 3.2 μm and add some of the excitation laser lights 212 from the excitation laser light oscillator 211 oscillating at a wavelength from 1.5 μm to 2.2 μm the treatment light.

Furthermore, the long-distance fiber light guide apparatus 30 in the medical laser light source system 10 shown in this drawing can be separated into a long-distance fiber (long) light guide apparatus 320 and a long-distance fiber (short) light guide apparatus 330. Yet further, a long-distance fiber (long) side exit terminal 321 and a long-distance fiber (short) side entrance terminal 331 are connected in a manner to be attachable and detachable, and the long-distance fiber (long) side exit terminal 321 is arranged in the treatment table 50.

In this way, various miniature 2.9 μm band laser devices 40 are mounted and a laser treatment light source that is optimal for the treatment target at the treatment table 50 can be set by suitably selecting a long-distance fiber (short) light guide apparatus 330 that is suitable for the target treatment from among the long-distance fiber (short) light guide apparatuses 330 in the lineup, and connecting the selected long-distance fiber (short) light guide apparatus 330 to the long-distance fiber (long) side exit terminal 321 of the treatment table 50 and attaching the module of the excitation laser light oscillator 211 that is optimal for the selected long-distance fiber (short) light guide apparatus 330 to the excitation laser light source unit 210. The terms “long-distance fiber (long)” and “long-distance fiber (short)” refer to the lengths of the fibers in the drawings, and do not refer to the actual dimensions of the optical fibers.

By using the excitation laser light source apparatus 20 such as described above, it is possible to independently and freely control the excitation laser light at each of the treatment tables 50a, 50b, and 50c to combine the pulse lights of the respective excitation laser lights to realize excitation laser light with high peak power, shift the pulse lights of the respective excitation laser lights to restrict the peak power and put out laser energy, and the like. Accordingly, it is possible to realize treatment according to an objective such as highly efficient ablation, making incisions in soft tissue that heals quickly, antiseptic processes, and the like.

The following describes variations that can be made when forming the lineup of excitation laser light oscillators 211 that can be used by the medical laser light source system 10 described above. MOFA laser oscillators can be used as examples of the solid state laser oscillators having an oscillation wavelength from 1.5 μm to 2.2 μm that can be used as the excitation laser light oscillators 211.

FIG. 13 shows the basic configuration of a MOFA excitation laser light oscillator 211 used for describing the usage example of the first embodiment. The Tm active fiber 290 is used to amplify the FBG laser oscillating at 1.92 μm, which has a relatively high absorption rate for Cr²⁺:CdSe and a relatively high absorption rate for water, as the first-type light 260.

As shown in the drawing, the first-type light 260 from the 1.78 μm distributed feedback laser is mixed with the 794 nm excitation LD 280 by the first mixer 270 and passes through the Tm active fiber 290, thereby resulting in the amplification and output of the 1.78 μm excitation laser light 212. By changing the oscillation pulse width and the repeating frequency of the first-type light 260 and also changing the output of the excitation LD 280 and modulating the excitation laser light 212, it is possible to change the 2.9 μm band laser treatment light 501 from the miniature 2.9 μm band laser device 40 to have an oscillation pulse width in a range from 10 ns to 1000 μs, an oscillation energy intensity in a range from 0.01 mJ to 2 J, and a repeating frequency in a range from 1 Hz to 1 MHz and output this 2.9 μm band laser treatment light 501.

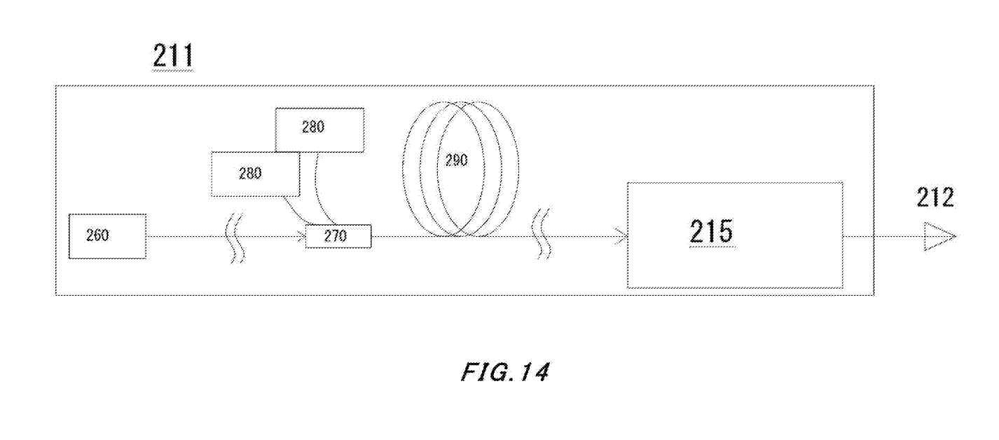

FIG. 14 shows another type of solid state excitation laser that is mostly a MOFA type. The laser shown in FIG. 14 further amplifies the excitation laser light 212 generated according to the MOFA shown in FIG. 13, and is used when a high energy output greater than or equal to 1 J is required. The amplification of the excitation laser light 212 is realized by a laser crystal medium such as YAG or YLF doped with rare earth ions such as Tm or Ho, or a solid state laser amplifier 215 using LD excitation with an expanded MOFA or a solid state laser amplifier 215 using flash lamp excitation.

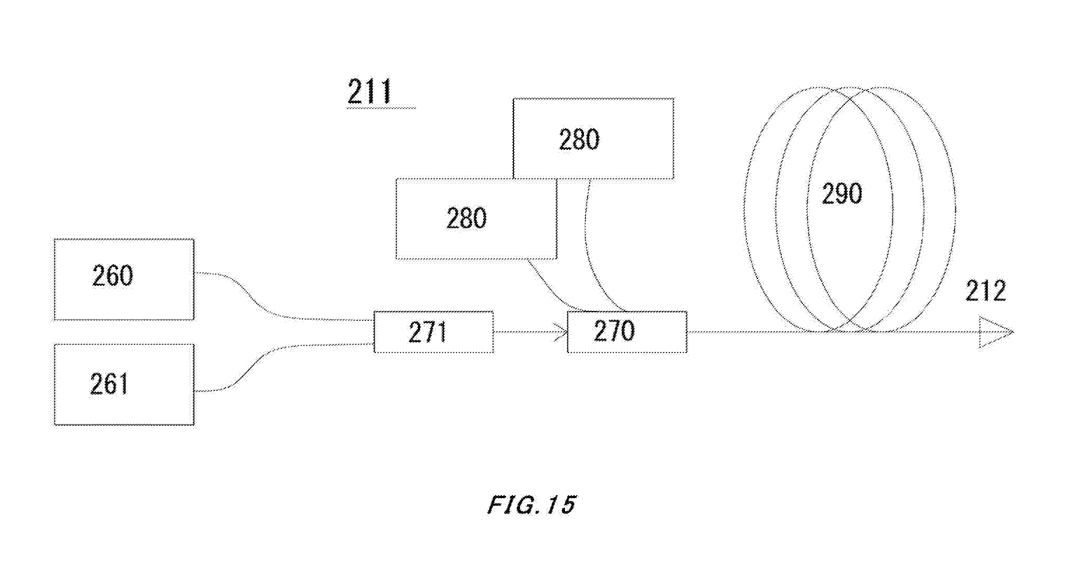

FIG. 15 shows a type of excitation laser system that uses a MOFA to amplify the output light from two solid state lasers that output different wavelengths. The laser system shown in FIG. 15 has respective light guide fibers of the first-type light 260 oscillating at 1.78 μm and the second-type light 261 oscillating at 1.92 μm connected to each other by a second mixer 271. Furthermore, a light guide fiber of the excitation LD 280 of the active fiber 290 is also connected by the first mixer 270. By combining the first mixer 270 and the second mixer 271, further multi-wavelength oscillation is possible in a range from 1.5 μm to 2.2 μm.

In the miniature 2.9 μm band laser device 40 used in the first embodiment example and second embodiment example, the resonator formed using the HR mirror 420 and the OC mirror 430 may be set as described in the following. In the resonator of the miniature 2.9 μm band laser device 40, the HR mirror 420 has a high transparency rate for a wavelength of 1.70 μm and a wavelength of 1.92 μm, e.g. a transparency rate greater than or equal to 85%. And the HR mirror 420 has a high reflection rate for the 2.9 μm band laser treatment light 501, e.g. a reflection rate greater than or equal to 99.5%.

In the resonator described above, the OC mirror 430 has a high reflection rate for a wavelength of 1.70 μm, e.g. a reflection rate greater than or equal to 90%, and a high transparency rate for a wavelength of 1.92 μm, e.g. a transparency rate greater than or equal to 80%. And the OC mirror 430 has a high transparency rate for the 2.9 μm band laser treatment light 501, e.g. a transparency rate greater than or equal to 75%.

From the miniature 2.9 μm band laser device 40 having a structure such as described above, in addition to the 2.9 μm band laser treatment light 501, the 1.92 μm excitation laser light 212 is also emitted at the same time. The 1.92 μm excitation laser light 212 is absorbed in suitable amounts by living tissue to realize a hemostatic effect. Furthermore, The 2.9 μm band laser treatment light 501 emitted with high efficiency by the excitation light with a wavelength of 1.70 μm and the excitation light with a wavelength of 1.92 μm realizes a strong incision effect. By simultaneously realizing the hemostatic effect and the incision effect, incision performance with excellent synergy is realized.

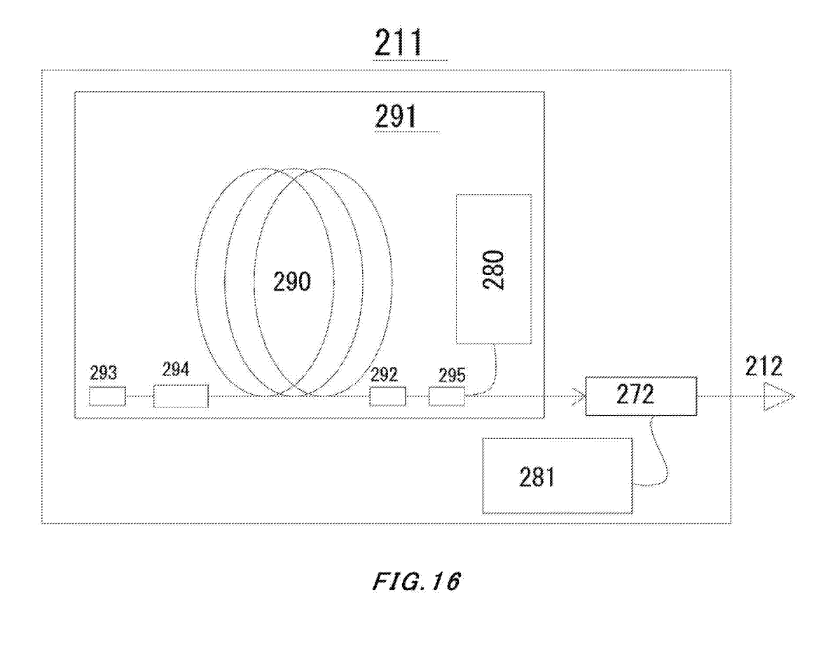

FIG. 16 shows a variation of the solid state excitation laser system used in the fiber laser 291. FIG. 16 shows an excitation laser light oscillator 211 having a structure in which a Q-switch pulse fiber laser 291 and an excitation laser light 212 of a strong pulse solid state laser oscillator 281 are mixed together by a third mixer 272.

Here, a flash lamp excitation Ho:YAG laser oscillating at 2.1 μm is used as the strong pulse solid state laser oscillator 281 and is mixed together with a Tm fiber laser 291 oscillating at 1.95 μm. Furthermore, the fiber laser 291 can be configured using a resonator element 293 (HR-FBG), a resonator element 292 (OC-FBG), an excitation LD 280, a Q-switch component 294, and a WDM coupler 295, thereby improving the producibility and lowering cost.

The characteristics of the HR mirror 420 and the OC mirror 430 are set such that the miniature 2.9 μm band laser device 40 of the medical laser light source system 10 in which the excitation laser light oscillator 211 is mounted performs excitation with the excitation laser light 212 having a wavelength of 1.95 μm and the excitation laser light 212 having a wavelength of 2.1 μm to output the 2.94 μm laser treatment light 501. In this way, it is possible to form the medical laser light source system 10 that oscillates at 2.94 μm, which is the absorption peak of water molecules.

Therefore, hard tissue can be efficiently ablated by using the 2.94 μm laser treatment light 501 that has 200 mJ/pulse (pulse width of 200 μs) and 20 Hz obtained when excited by the strong pulse solid state laser oscillator 281. And incisions can be made in soft tissue while performing hemostasis by using the laser treatment light 501 obtained from excitation by the fiber laser 291 having a high repeating frequency of 200 kHz at 100 μJ/pulse. Furthermore, it is possible to minimize thermal damage and efficiently perform incisions while performing hemostasis in soft tissue by using the 1 W 2.94 μm laser treatment light 501 realized by the 50 mJ and 100 kHz fiber laser 291 caused by the excitation of the 60 Hz strong pulse solid state laser oscillator 281.

Lasers other than the flash lamp excitation Ho:YAG laser oscillating at a 2.1 μm band, such as an LD excitation Tm:YAG laser oscillating at a 2.0 μm band, a flash lamp excitation Er:YAG laser oscillating at a 1.7 μm band, or a laser oscillating in the same wavelength band using OPO, may be used as the strong pulse solid state laser oscillator 281.

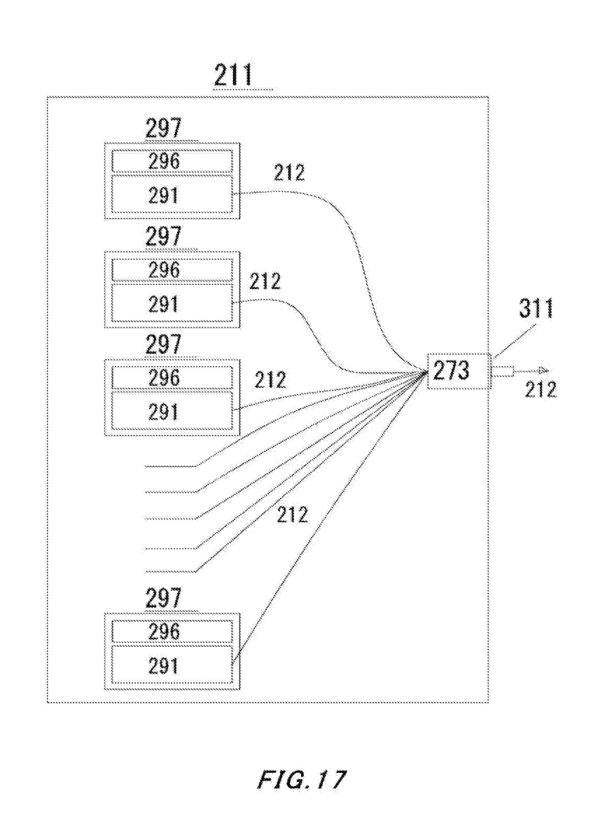

FIG. 17 shows another variation of the solid state excitation laser system using the fiber laser 291. A plurality of fiber laser modules 297, which are each formed by a pulse fiber laser 291 formed by components that are the optical elements described above and a sub controller 296 that stores control data of the pulse fiber laser 291 and controls the pulse width, repeating frequency, output, and the like, and this system has a structure to integrate the excitation laser lights 212 from the respective fiber lasers 291 and output the result.

Among the fiber laser modules 297, Q-switch fiber laser modules 297 oscillating in a range from 1.5 μm to 2.2 μm are suitably selected, and a number of fiber laser modules 297 enabling an output corresponding to the objective treatment are mounted in the excitation laser light oscillator 211. And each fiber laser module 297 is configured in a manner to be able to output, according to the corresponding sub controller 296, the excitation laser light 212 with a pulse width in a range from 10 ns to 1000 μs, a repeating frequency in a range from 1 Hz to 1 MHz, and output energy of approximately 10 mJ.

The sub controller 296 mounted in each fiber laser module 297 is controlled by the main controller 241 of the control display unit 240. According to instructions from the control console 250, each sub controller 296 adopts the set oscillation conditions of the 2.9 band laser treatment light 501, and each fiber laser module 297 outputs the excitation laser light 212 corresponding to the instructions of the main controller 241.

The excitation laser lights 212 emitted from the respective fiber laser modules 297 are gathered and mixed together by the fourth mixer 273, and the resulting laser light is guided from the excitation light entrance opening 311 of the excitation laser light source apparatus 20 to the quartz fiber cord 312. With the structure described above, by integrating the pulse energies of fiber lasers 291 that each have low power when alone, a power lineup including large powers corresponding to the intended use can be easily realized.

Furthermore, by using the structure in which the sub controller 296 of each fiber laser module 297 is controlled by the main controller 241, the excitation laser light 212 can be formed to have an arbitrary waveform. Therefore, it is possible to realize a waveform of the 2.9 μm band laser treatment light 501 that provide the optimal effect for the objective treatment.

In the excitation laser light oscillator 211 using the MOFA shown in FIGS. 13, 14, and 15, each sub controller 296 described above may control the first-type light 260 to control the oscillation repeating frequency (1 Hz to 1 MHz) and the oscillation pulse width (10 ns to 1000 μs).

Furthermore, in the excitation laser light oscillator 211 shown in FIG. 16, each sub controller 296 described above may control the Q-switch component 294 to control the oscillation repeating frequency (1 Hz to 1 MHz) and the oscillation pulse width (10 ns to 1000 μs).

Furthermore, in the excitation laser light oscillator 211 shown in FIG. 11, if the excitation laser light oscillator 211 using the MOFA shown in FIGS. 13, 14, and 15 or the excitation laser light oscillator 211 shown in FIG. 16 is adopted, a plurality of sub controllers 296 corresponding respectively to the excitation laser light oscillators 211 and the fiber lasers 291 are included. In this way, in each excitation laser light oscillator 211, the sub controller 296 individually controls the oscillation energy intensity, the oscillation pulse width, the repeating frequency, and the peak power of the fiber laser 291.

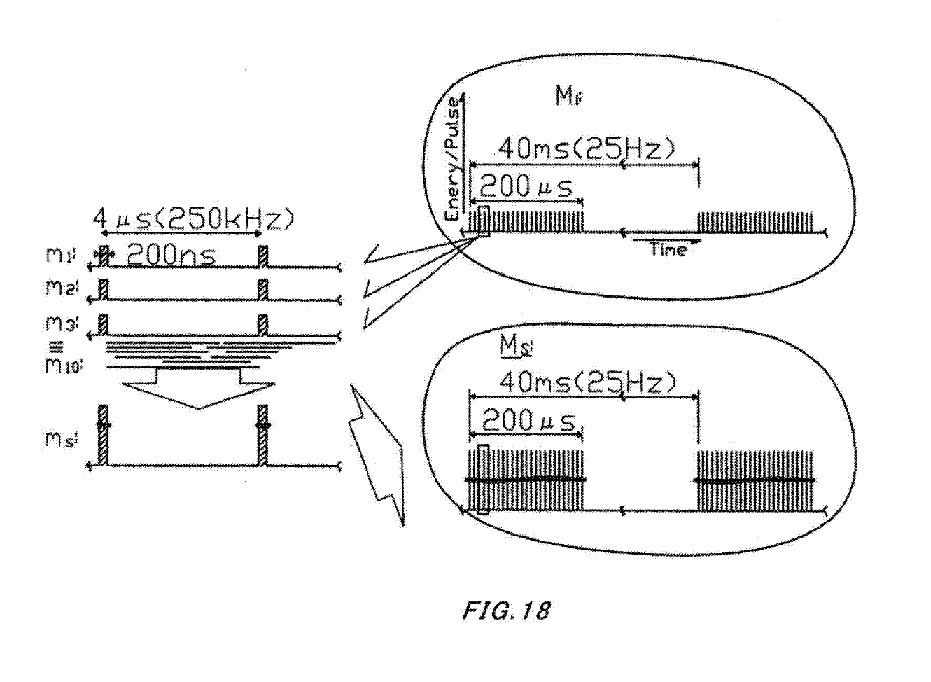

FIG. 18 schematically shows controlled waveforms of excitation laser lights 212 output as a result of the main controller 241 controlling each fiber laser module 297. In the example shown in the drawing, the settings input from the control console 250 designate a pulse width of 200 μs, a repeating frequency of 25 Hz, a pulse energy of 200 mJ for the 2.9 μm band laser treatment light 501, and a peak power of “high.”

In response to these settings, the sub controllers 296 of ten fiber laser modules 297 are caused by the main controller 241 of the control display unit 240 to oscillate, at the same timing, the 750 μJ excitation laser light 212 with a pulse width of 300 ns and a repeating frequency of 250 kHz. Furthermore, a signal causing macro-oscillation with a pulse width of 200 μs and a repeating frequency of 25 kHz is transmitted, and the micro-pulse excitation laser lights 212 of the ten oscillation waveforms mi having a peak power of 2.5 kW are oscillated simultaneously in the macro-oscillation waveform Mi with a pulse width of 200 μs of each fiber laser module 297.

It is possible to control the oscillation of the 375 mJ/macro-pulse excitation laser light 212 having an oscillation waveform MS with a peak power of 25 kW formed by the micro-pulses of the oscillation waveform ms obtained by integrating the waveforms m1 to m10. Accordingly, it is possible to perform pulse-oscillation of the 2.9 μm band laser treatment light 501 having a peak power of approximately 13 kW, a repeating frequency of 25 Hz, and 200 mJ/macro-pulse, which is suitable for ablation of hard tissue, from the miniature 2.9 μm band laser device 40.

In the medical laser light source system 10 in which the excitation laser light source unit 210 shown in FIG. 17 is mounted, the control console 250 enabling a selection of “high,” “medium,” and “low” for the peak power may also be mounted, for example.

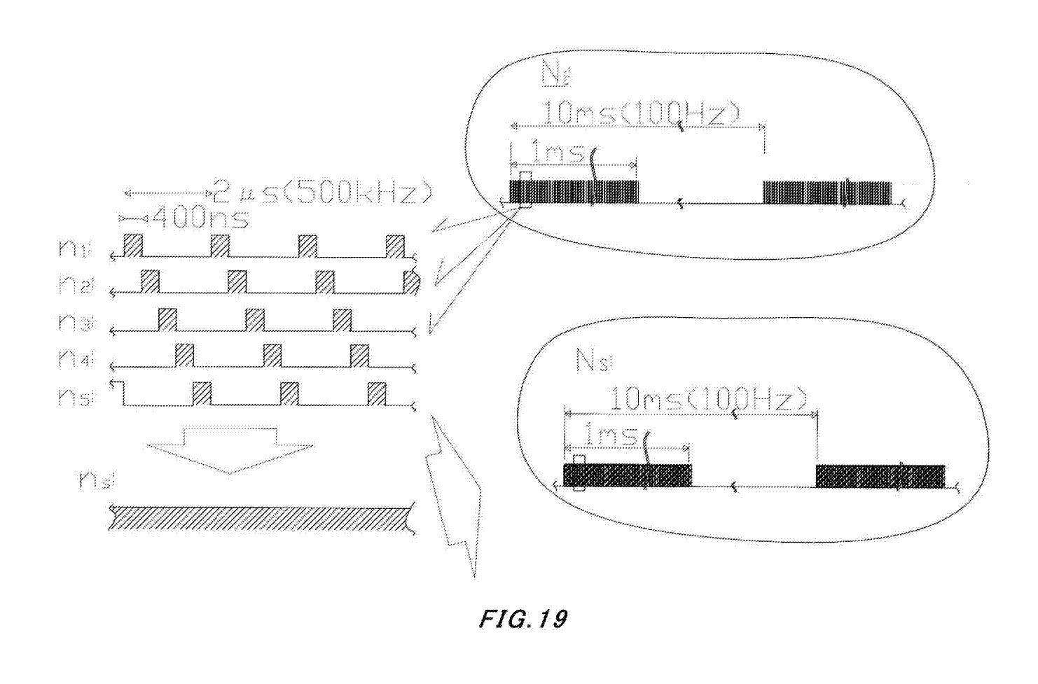

FIG. 19 is a schematic view of a controlled waveform of the excitation laser light 212 output as a result of the main controller 241 controlling each fiber laser module 297. In the example shown in the drawing, the settings input from the control console 250 designate a pulse width of 1 ms, a repeating frequency of 100 Hz, a pulse energy of 50 mJ for the 2.9 μm band laser treatment light 501, and a peak power of “low.”

In response to these settings, each of the sub controllers 296 of five fiber laser modules 297 are caused by the main controller 241 to oscillate, at timings respectively shifted by 400 ns, the excitation laser light 212 with a pulse width of 400 ns, a repeating frequency of 500 kHz, and 20 μJ/micro-pulse. Furthermore, a signal causing macro-oscillation with a pulse width of 1 ms and a repeating frequency of 100 Hz is transmitted, and micro-pulse excitation laser lights 212 of the five oscillation waveforms ni having a peak power of 0.05 kW are oscillated at timings respectively shifted by 400 ns in the macro-oscillation waveform Ni with a pulse width of 1 ms of each fiber laser module 297.

It is possible to control the oscillation of the 50 mJ/macro-pulse excitation laser light 212 having an oscillation waveform NS with a peak power of 0.05 kW formed by the micro-pulses of the oscillation waveform ns obtained by integrating the waveforms n1 to n5. In this way, it is possible to perform oscillation of the 2.9 μm band laser treatment light 501 having 3 W (30 mJ/macro-pulse) with a high repeating frequency (100 Hz) and a low peak power of approximately 30 W, which is suitable for performing hemostasis when making incisions of soft tissue, from the miniature 2.9 μm band laser device 40.

As described above, by mounting the excitation laser light oscillator 211 having the structure shown in FIG. 17, the pulse lights of the excitation laser lights 212 from the respective fiber laser modules 297 forming the excitation laser light oscillator 211 are combined, and it is possible to form the excitation laser light 212 with high peak power (see FIG. 18). Furthermore, by temporally shifting these pulse lights to restrict the peak power, it is possible to freely control the laser energy that can be put out.

It should be noted that the medical laser light source system 10 may be configured such that the long-distance fiber (short) light guide apparatus 330 with the miniature 2.9 μm band laser device 40 provided therein can be attached to and detached from the treatment table 50. In particular, in the third embodiment example described above, the long-distance fiber light guide apparatus 30 can be separated from the long-distance fiber (short) light guide apparatus 330 that can be detached from the treatment table 50.

Furthermore, the miniature 2.9 μm band laser device 40 may be formed with a laser medium 410 having a broad oscillation wavelength region of 2 μm to 3 μm. In this way, the long-distance fiber (short) light guide apparatus 330 having provided therein the miniature 2.9 μm band laser device 40 that emits the laser treatment light 501 with a wavelength in a range from 2 μm to 3 μm that is a clinically optimal target can be attached to the treatment table 50 to perform treatment.

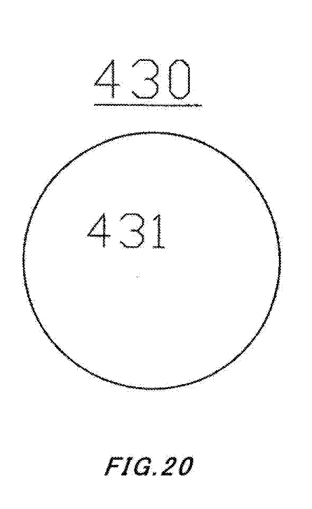

FIG. 20 shows an exemplary layout of an OC film 431 of the OC mirror 430 forming the laser resonator in the miniature 2.9 μm band laser device 40. By setting specifications suitable for laser oscillation with wavelength of 2.94 μm for the OC film 431 shown in the figure, it is possible to attach the long-distance fiber (short) light guide apparatus 330 with the miniature 2.9 μm band laser device 40 provided therein to the treatment table 50 and perform treatment that prioritizes the ablation of living tissue. Furthermore, by attaching the long-distance fiber (short) light guide apparatus 330 equipped with the OC mirror 430 in which the OC film 431 is formed for use with a wavelength of 2.70 μm to the treatment table 50, it is possible to perform sterilization to a depth (10 μm) of the same wavelength in a living organism.

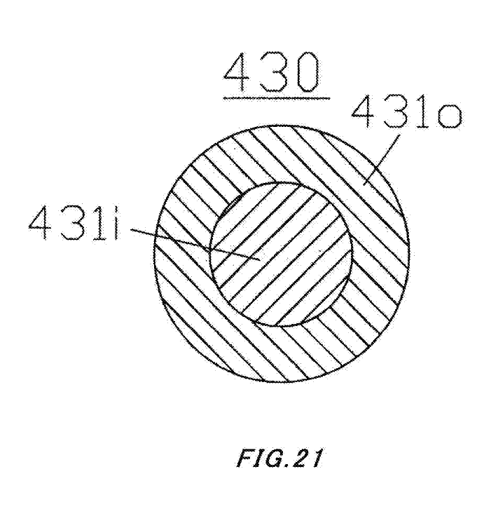

FIG. 21 shows the OC film 431 of the OC mirror 430 forming the laser resonator of the miniature 2.9 μm band laser device 40. In this OC mirror 430, an OC film 431i that transparently passes 40% of a 2.94±3 μm wavelength and is highly reflective (at least 99% reflective) with respect to other oscillation wavelength regions is formed in a central portion of the OC mirror 430, and an OC film 4310 that transparently passes 5% of a 2.70±3 μm wavelength and is highly reflective (at least 99% reflective) with respect to other oscillation wavelength regions is formed in a peripheral edge portion. By attaching a long-distance fiber (short) light guide apparatus 330 equipped with such an OC mirror 430, it is possible to simultaneously perform irradiation with the 2.70 μm laser treatment light 501 and the 2.94 μm laser treatment light 501.

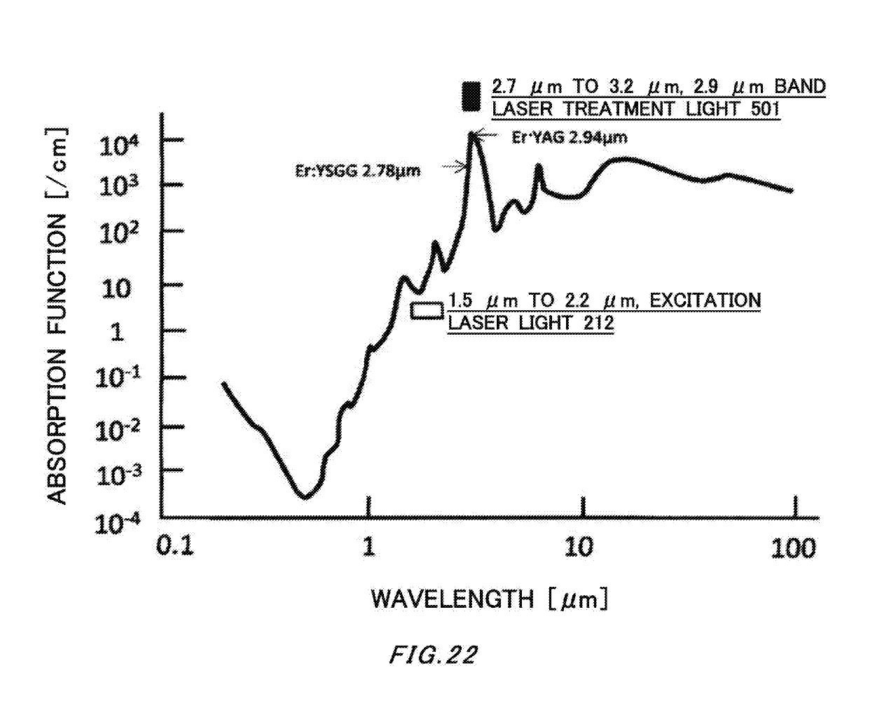

FIG. 22 is a graph showing an absorption spectrum of water molecules. As shown in the drawing, water molecules have an absorption bandwidth with a peak at a wavelength of 2.94 μm.

On the other hand, there are two types of flash lamp excitation Er pulse laser treatment devices, which are an Er:YAG laser and an Er:YSGG laser, according to a difference in the laser medium. These laser mediums have determined oscillation wavelength regions, whereby the Er:YAG is limited to 2.94 μm and the Er:YSGG is limited to 2.78 μm. As shown in FIG. 22, both of the 2.9 μm band wavelengths are significantly absorbed by water, but the absorption rate for the 2.94 μm wavelength by water is three times higher than the absorption rate for the 2.78 μm wavelength by water.

Therefore, the Er:YAG laser can sharply ablate hard tissue and soft tissue, but has a low hemostatic capability for soft tissue. On the other hand, the Er:YSGG laser has an excellent hemostatic capability, but has poor ablation capabilities. Therefore, when one of these wavelengths is used alone, one of these clinical effects is selected exclusively. Furthermore, flash lamp excitation also has limited control range for the laser oscillation parameters, such as having difficulty realizing a high repeating frequency, and this limits the clinical applicability of conventional Er pulse laser treatment devices.

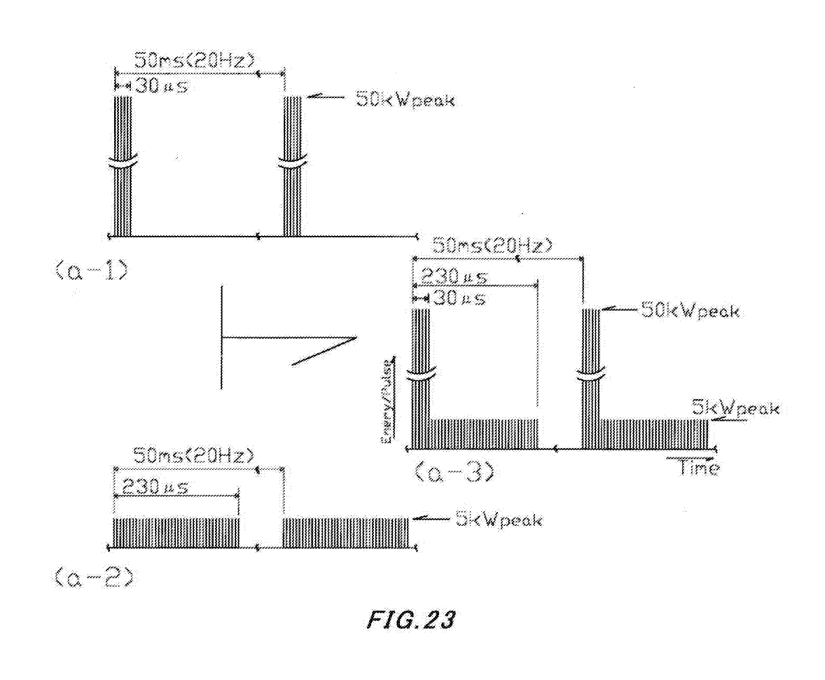

In contrast to this, with the medical laser light source system 10 according to the third embodiment example described above, as shown in FIG. 23, by using the excitation laser light source unit 210 in which two excitation laser light oscillators 211 configured as shown in FIG. 17 are mounted, one of the excitation laser light oscillators 211 outputs the laser treatment light 501 shown by (a-1) of FIG. 23 and the other excitation laser light oscillator 211 outputs the laser treatment light 501 shown by (a-2) of FIG. 23, and therefore it is possible to obtain the laser treatment light 501 shown by (a-3) of FIG. 23.

In other words, one of the excitation laser light oscillators 211 outputs the 2.94 μm laser treatment light 501 at a repeating frequency of 20 Hz with a short pulse width of 30 μs and low energy of 20 mJ per pulse, but a high peak power of 50 kW. On the other hand, the other excitation laser light oscillator 211 outputs the 2.94 μm laser treatment light 501 at a repeating frequency of 20 Hz with a relatively low peak power of 5 kW, but a pulse width of 230 μs and an energy of 100 mJ per pulse.

Then, by mixing the 2.94 laser treatment light 501 of the one excitation laser light oscillator 211 with the 2.94 μm laser treatment light 501 of the other excitation laser light oscillator 211, it is possible to obtain the 2.94 μm laser treatment light 501 with 120 mJ per pulse, such as shown by (a-3) in FIG. 23.

With the 2.94 μm laser treatment light 501 having such a waveform, it is possible to perform high-efficiency ablation, even with a relatively low energy, to immediately ablate the hardest layer of enamel, which is the surface layer of the enamel, with a pulse having a high peak power during the initial oscillation shown in (a-3) of FIG. 23 and an energy of 200 mJ per pulse, which is necessary for efficiently ablating the enamel material of dental hard tissue. With such a structure, it is possible to freely create an oscillation waveform having an energy and a peak power that have been optimized while not exceeding a damage threshold of 1 MW/mm² that can be transmitted by quartz fiber.

Here, as the excitation laser light oscillator 211 for obtaining the 2.94 μm laser treatment light 501 having a long pulse width, a flash lamp excitation Ho:YAG laser, for example, can be mounted instead of the excitation laser light oscillator 211 configured as shown in FIG. 17.

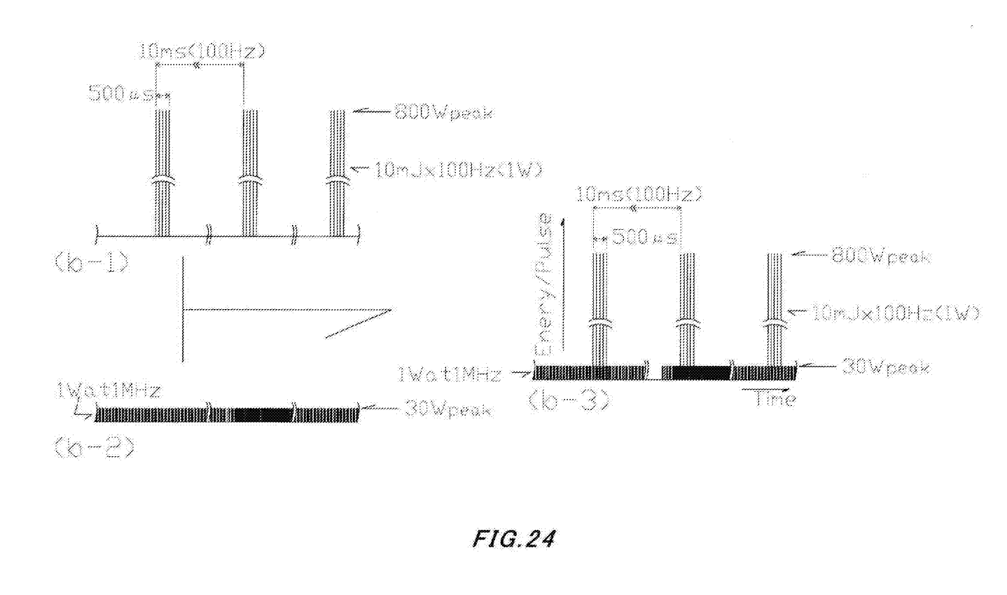

FIG. 24 shows yet another form using the excitation laser light source unit 210 in which two of the excitation laser light oscillators 211 configured as shown in FIG. 17 are mounted, in the same manner as described above. One of the excitation laser light oscillators 211 outputs the laser treatment light 501 shown by (b-1) in FIG. 24 and the other excitation laser light oscillator 211 outputs the laser treatment light 501 shown by (b-2) in FIG. 24, and therefore it is possible to obtain the laser treatment light 501 shown by (b-3) of FIG. 24.

One of the excitation laser light oscillators 211 outputs the 2.94 μm laser treatment light 501 with a pulse width of 500 μs having a repeating frequency of 100 Hz and 10 mJ per pulse, and accordingly the 2.94 μm laser treatment light 501 has an average power of 1 W with a peak power of 800 W. The other excitation laser light oscillator 211 outputs the 2.94 μm laser treatment light 501 with continuous oscillation having a repeating frequency of 1 MHz and with an average power of 1 W and a low peak power of 30 W.

Then, by mixing the 2.94 laser treatment light 501 of the one excitation laser light oscillator 211 with the 2.94 μm laser treatment light 501 of the other excitation laser light oscillator 211, it is possible obtain the 2.94 μm laser treatment light 501 with a total average power of 2 W, such as shown by (b-3) in FIG. 24.

With the 2.94 μm laser treatment light 501 having such a waveform, it is possible to perform an incision in the soft tissue that heals quickly by sharply ablating the soft tissue with a region of (b-1) shown in FIG. 24, which has a peak power high enough for the soft tissue, as well as performing hemostasis by the moderate heating for minimizing the heat damaged portion using the region (b-2) shown in FIG. 24 that has low peak power.

Here, as the excitation laser light oscillator 211 for obtaining the 2.94 μm laser treatment light 501 having continuous oscillation, a CW fiber laser, for example, can be mounted instead of the excitation laser light oscillator 211 configured as shown in FIG. 17. However, if it is necessary to perform an adjustment of the suitable peak power, the excitation laser light oscillator 211 having the configuration shown in FIG. 17 is suitable (for example, a CW fiber laser having an average power of 1 W has a peak power of 1 W as well. In the present configuration, however, it is possible to set a higher peak power for the average power of 1 W, so that regulation of the heat damage is possible).

By attaching to the treatment table 50 the long-distance fiber (short) light guide apparatus 330 in which is mounted the miniature 2.9 μm band laser device 40 designed such that a portion of the 1.92 μm excitation laser light 212 is transparently passed in addition to the 2.94 μm excitation laser light 212 and the 2.70 μm excitation laser light 212 using the OC mirror 430 configuration shown in FIG. 21 described above and mounting an excitation laser light oscillator 211 that is capable of the laser oscillation shown in (b-2) of FIG. 24, it is possible to simultaneously output the 2.70 μm laser treatment light 501 and the 2.94 μm laser treatment light 501 with 1.92 μm laser lights that each have 0.5 W, for example. With such irradiation, it is possible to perform a sterilization process up to 100 μm into a living organism (see FIG. 22. Penetration depth: 2.94 μm=approximately 1 μm, 2.70 μm=approximately 10 μm, and 1.92 μm=approximately 100 μm).

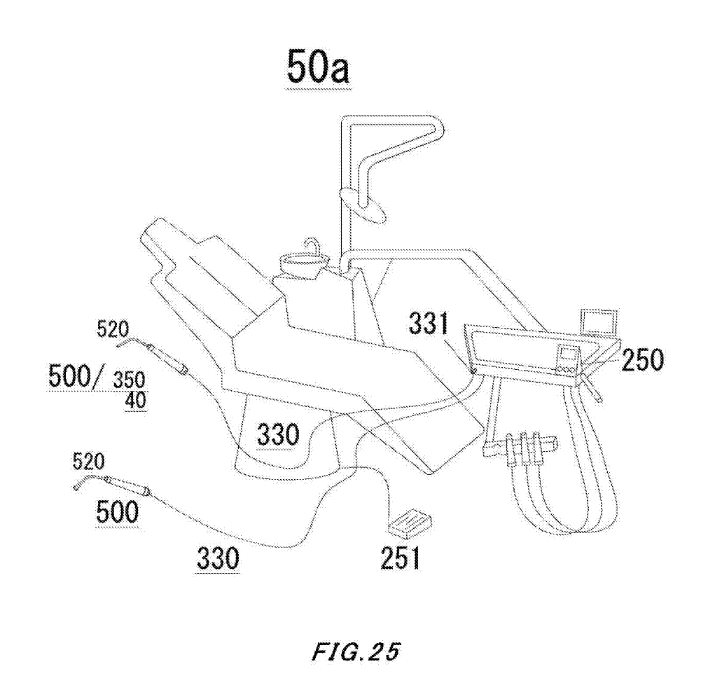

On the other hand, as made clear from the configuration of the medical laser light source system 10 according to the third embodiment example, it is possible to attach to the treatment table 50 not one but a plurality of long-distance fiber (short) light guide apparatuses 330 (see FIG. 25) having mounted therein a miniature 2.9 μm band laser device 40 capable of performing a lineup of various treatments.

As an example, three excitation laser light oscillators 211 having different laser oscillation parameters such as described above are mounted in the excitation laser light source unit 210, and a long-distance fiber (short) light guide apparatus 330 for a 2.94 μm laser treatment light 501 and long-distance fiber (short) light guide apparatuses 330 for 2.94 μm, 2.70 μm, and 1.92 μm laser treatment lights 501 are attached to the treatment table 50. The operator inputs the processing conditions (in this case, hard tissue cutting and a sterilization process) for each long-distance fiber (short) light guide apparatus 330 into the control console 250 and, by stepping on the foot switch 251, can cause the main controller 241 in the excitation laser light source apparatus 20 to control the excitation laser light oscillator 211 to output the 2.94 μm laser treatment light 501 shown by (a-1) and (a-2) of FIG. 23 and to also control the photomixer 216 and the light switching switch 214 to oscillate the 2.94 μm laser treatment light 501 with the shape shown by (a-3) of FIG. 23, while also causing the main controller 241 to control the excitation laser light oscillator 211 capable of the laser oscillation shown by (b-2) of FIG. 24 to control the photomixer 216 and the light switching switch 214 to oscillate the 2.94 μm, 2.70 μm, and 1.92 μm laser treatment lights 501 with the shape shown by (b-2) of FIG. 24. In other words, it is possible to use the two types of dental handpieces 500 mounted therein to simultaneously perform sterilization of tissue near the teeth and a process of cutting the hard tissue.

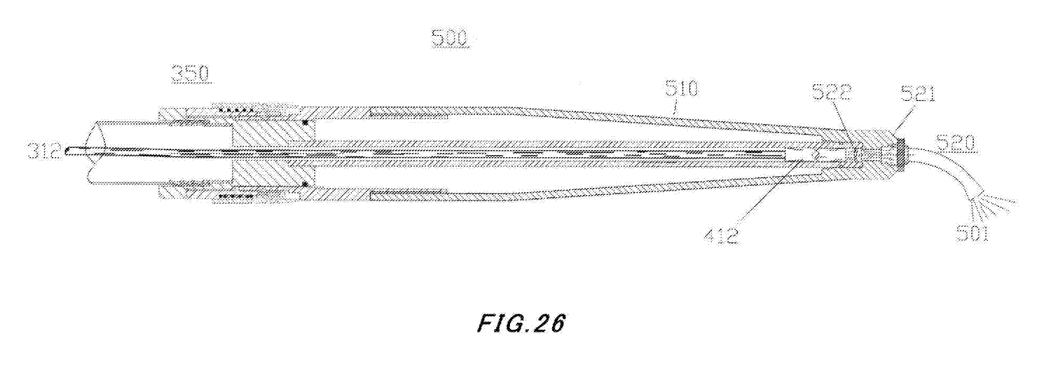

Furthermore, FIG. 26 shows a dental handpiece 500, without having a miniature 2.9 μm band laser device 40 mounted therein, that can focus the excitation laser light 212 from the excitation laser light source unit 210 (which cannot actually be called excitation light) directly on the irradiation tip 520.

Aside from treatment with the 2.94 μm band laser treatment light 501, the present invention can also be used for resin polymerization by, in the medical laser light source system 10 according to the third embodiment example, attaching to the treatment table 50 the long-distance fiber (short) light guide apparatus 330 having the dental handpiece 500 shown in FIG. 26 attached thereto and mounting a blue LED on the excitation laser light source unit 210.

Although a blue LED is mounted in this example, it is also possible to perform treatment with a red LED or infrared LED said to have other pain-reducing effects being mounted.

As described above, the medical laser light source system 10 of the present embodiment is formed by at least three main components, which are the excitation laser light source apparatus 20, the long-distance fiber light guide apparatus 30, and the miniature 2.9 μm band laser device 40. The long-distance fiber light guide apparatus 30 is formed by a quartz fiber with a low OH concentration less than or equal to 10 pp that is widely used in optical communication, has flexibility, has excellent environmental endurance, and has high mechanical strength. The miniature 2.9 μm band laser device 40 is formed by a group II-VI semiconductor (ZnSe, ZnS, CdSe, CdTe, etc.) with a medium length greater than or equal to 3 mm doped with transitional metal ions (Cr²⁺, Fe²⁺, Co²⁺, etc.) that have oscillation bands in a broad wavelength region from 2.7 μm to 3.2 μm, the laser medium 410 being capable of performing excitation at a wavelength region from 1.5 μm to 2.2 μm that enables long-distance communication through the quartz fiber with the low OH concentration. The excitation laser light source apparatus 20 is formed by a solid state laser oscillator that oscillates with a wavelength region from 1.5 μm to 2.2. μm.

Furthermore, the medical laser light source system 10 according to the present embodiment is configured such that the light switching switch 214 is mounted on the front end of the focusing unit 213 of the excitation laser light source unit 210 in the excitation laser light source apparatus 20, the excitation laser light 212 is guided to a treatment table 50 used for treatment through the long-distance fiber light guide apparatus 30 incorporating the quartz fiber with the low OH concentration less than or equal to 10 ppm connected to the treatment table 50 in the treatment facility according to a selection made by the operator by switching the light switching switch 214 to output the laser treatment light from the miniature 2.9 μm band laser device 40 connected to the selected treatment table 50.

In an example where the treatment facility is a dental hospital, the destination to which the excitation laser light 212 is guided and transmitted can be selectively switched among a plurality of long-distance fiber light guide apparatuses 30 connected to each of the treatment tables 50. With this structure, by arranging one excitation laser light source apparatus 20 that is a relatively large apparatus among the medical laser light source system 10 at an arbitrary location within the treatment facility, it is possible to guide the excitation laser light 212 between the excitation laser light source apparatus 20 and the plurality of the treatment tables 50 set in the treatment facility through an inexpensive and simple long-distance fiber light guide apparatus 30, without requiring refilling of dry air or specialized support structures.

By having the operator manipulate a control console 250 arranged at each treatment table 50, the excitation laser light 212 is guided to the treatment table 50 selected by the operator using the light switching switch 214, and the 2.9 μm band laser treatment light 501 necessary for the treatment is supplied by having been pumped by the miniature 2.9 μm band laser device 40 attached inside the back end of the dental handpiece 500 held by the operator.

Furthermore, the medical laser light source system 10 according to the present embodiment includes the following mechanisms that can significantly expand the clinical applicability by utilizing the broad range of the oscillation wavelength region and the excitation wavelength region of the laser medium, which is a group II-VI semiconductor doped with transitional metal ions, taking maximum advantage of the characteristics of the 2.9 μm band light, and also adding the wavelength band of the excitation light source to the treatment light.

In other words, the excitation laser light source unit 210 is configured such that a module is formed from various excitation laser light oscillators 211 that have oscillation wavelengths in a bandwidth from 1.5 μm to 2.2 μm and have various different laser oscillation parameters such as oscillation energy intensity, oscillation pulse width, repeating frequency, and peak power, one or more of the excitation laser light oscillators 211 suitably selected from this line up can be attached easily to the excitation laser light source unit 210, and the excitation laser lights from these excitation laser light oscillators 211 can be focused by the long-distance fiber light guide apparatus 30 and guided to the miniature 2.9 μm band laser device 40.

Furthermore, the medical laser light source system 10 is configured such that the miniature 2.9 μm band laser device 40 is prepared to be able to oscillate the laser treatment light 501 at one or more suitably selected wavelengths from 2.7 μm to 3.2 μm and to select various combinations obtained by adding portions of the excitation laser light 212 in the 1.5 μm to 2.2 μm band from the excitation laser light oscillator 211 to the treatment light as needed, and such that the long-distance fiber light guide apparatus 30 can be separated into the long-distance fiber (long) light guide apparatus 320 and the long-distance fiber (short) light guide apparatus 330 having the miniature 2.9 μm band laser device 40 mounted in the tip and can be connected in an attachable and detachable manner to the long-distance fiber (long) side exit terminal 321 and the long-distance fiber (short) side entrance terminal 331.

With the structure described above, the medical laser light source system 10 is provided that is optimal for each type of clinical treatment, by suitably selecting a long-distance fiber (short) light guide apparatus 330 that is suitable for the target treatment from a lineup of the long-distance fiber (short) light guide apparatuses 330 (each miniature 2.9 μm band laser device 40 has mounted therein a variety of combinations that can be selected), connecting the selected long-distance fiber (short) light guide apparatus 330 to the long-distance fiber (long) side exit terminal 321 of the treatment table 50, and attaching the optimal excitation laser light oscillator 211 module to the excitation laser light source unit 210.

On the other hand, the medical laser light source system 10 according to the present embodiment has mounted thereon the excitation laser light oscillator 211 comprised of the laser medium that is a group II-VI semiconductor having a long medium length (>3 mm) manufactured by depositing transitional metals and dispersing the transitional metals through annealing in the side surface of a rod or the like cut from a group II-VI semiconductor ingot manufactured using zone melting or the Bridgman method, and it is possible to output the laser energy necessary for the target treatment with this structure.

With the medical laser light source system 10 according to the present embodiment, it is possible to arrange the excitation laser light source apparatus 20 that is a relatively large apparatus forming the medical laser light source system 10 at an arbitrary location in the treatment facility, the excitation laser light 212 can be guided from the excitation laser light source apparatus 20 to the treatment table 50 to perform sterilization or ablation treatment of living tissue necessary in the medical facility, and in a dental hospital, for example, the excitation laser light 212 can be guided to the dental handpiece 500 arranged in the treatment table 50 ablation through the long-distance fiber light guide apparatus 30 that has a simple structure and does not require a refill of dry air or specialized support structures, and the 2.9 μm band laser treatment light 501 necessary for the treatment and sterilization can be provided by exciting the miniature 2.9 μm band laser device 40 attached to the inside of the back end of the dental handpiece 500 with the excitation laser light 212. Therefore, the operator can perform suitable treatment without stress.

In the present embodiment, the 2.9 μm band laser treatment light 501 can be supplied to a plurality of treatment tables 50 from one excitation laser light source apparatus 20 by the light switching switch 214, and the 2.9 μm laser treatment light 501 can be emitted to an arbitrary treatment table 50 by the operator's manipulation of the control console 250 provided at the treatment table 50.

Furthermore, in the present embodiment, one or more excitation laser light oscillators 211 selected from a module of various excitation laser light oscillators 211 that have oscillation wavelengths in a bandwidth from 1.5 μm to 2.2 μm and have various different laser oscillation parameters such as oscillation energy intensity, oscillation pulse width, repeating frequency, and peak power can be mounted and controlled. The excitation laser light source unit 210 is configured such that a plurality of excitation laser lights 212 from these excitation laser light oscillators 211 can be focused by the long-distance fiber light guide apparatus 30 and guided to the miniature 2.9 μm band laser device 40.

Furthermore, the medical laser light source system 10 is configured such that the miniature 2.9 μm band laser device 40 is prepared to be able to oscillate the laser treatment light 501 at one or more suitably selected wavelengths from 2.7 μm to 3.2 μm and to select various combinations of portions obtained by adding the excitation laser light 212 in the 1.5 μm to 2.2 μm band from the excitation laser light oscillator 211 to the treatment light as needed, and such that the long-distance fiber light guide apparatus 30 can be separated into the long-distance fiber (long) light guide apparatus 320 and the long-distance fiber (short) light guide apparatus 330 having the miniature 2.9 μm band laser device 40 mounted in the tip and can be connected in an attachable and detachable manner to the long-distance fiber (long) side exit terminal 321 and the long-distance fiber (short) side entrance terminal 331.

In this way, by suitably selecting a long-distance fiber (short) light guide apparatus 330 suitable for the target treatment from a lineup of long-distance fiber (short) light guide apparatuses 330 and connected the selected long-distance fiber (short) light guide apparatus 330 to the long-distance fiber (long) side exit terminal 321 of the treatment table 50 or attaching a module of the optimal excitation laser light oscillators 211 to the excitation laser light source unit 210, it is possible to form the medical laser light source system 10 that is optimal for the target treatment, and compared to conventional Er laser treatment devices that can only perform treatment at a single wavelength (2.94 μm for Er:YAG and 2.78 μm for Er:YSGG), it is possible to perform treatment with one or more optimal wavelengths selected from a range from 2.7 μm to 3.2 μm.

Furthermore, in the present embodiment, since a portion of the excitation laser light 212 from the excitation laser light oscillator 211 oscillating at a wavelength from 1.5 μm to 2.2 μm can be added to the treatment light and since the laser oscillation parameters such as the oscillation pulse width, the repeating frequency, the peak power, the oscillation waveform, the laser energy output intensity, and the like can be controlled within a wide range, it is possible to significantly expand the clinical applicability to include external surgery, sterilization, and the like in addition to being used for ablation of teeth and incisions in soft tissue near the teeth ablation performed using a conventional Er pulse laser treatment device, and it is also possible to prepare the medical laser light source system 10 to take maximum advantage of the characteristics of the 2.9 μm light for each target treatment.

Furthermore, in the present embodiment, the medical laser light source system 10 is formed by the excitation laser light source apparatus 20 and the long-distance fiber light guide apparatus 30 in which the coupler section 350 housing the miniature 2.9 μm band laser device 40 is attached to the front tip of the quartz fiber used as light guiding material, and the miniature 2.9 μm band laser device 40 has a broad wavelength absorption region from 1.5 μm to 2.2 μm.

Furthermore, by using the group II-VI semiconductor doped with transitional metal ions that have a broad oscillation wavelength region from 2.7 μm to 3.2 μm, it is possible to use various combinations of the miniature 2.9 μm band laser device 40 and the excitation laser light oscillator 211 such as described above. With these various combinations, it is possible to apply the present invention to both a treatment requiring the strong pulse oscillation described above and a treatment requiring CW oscillation or oscillation with a high repeating frequency close to CW, and since suitable 2.9 μm band wavelengths can be suitably selected without being fixed to a single wavelength, it is possible to apply the present invention to a wide range of treatments that cannot be realized with conventional medical lasers.

As described above, with the medical laser light source system 10, by having one excitation laser light source apparatus 20 arranged at an arbitrary location in a treatment facility and connected to all of the treatment tables by the long-distance fiber light guide apparatus 30 made of low-OH quartz, it is possible to easily supply these treatment tables with the laser treatment light 501 needed for treatment. By using the miniature 2.9 μm band laser device 40 in which the laser medium 410 is formed of a group II-VI semiconductor that has a medium length greater than 3 mm and is doped with transitional metal ions having a broad absorption wavelength region from 1.5 μm to 2.2 μm and an oscillation wavelength region from a 2.7 μm to 3.2 μm and, it is possible to form a lineup of various miniature 2.9 μm band laser devices 40 that can output a portion of the excitation laser light and a suitably selected oscillation wavelength in the 2.9 μm band, as the treatment light.

Furthermore, the medical laser light source system 10 forms a lineup of various solid state excitation laser light sources that oscillate in a band from 1.5 μm to 2.2 μm as the excitation laser light oscillators 211, and excitation laser light source apparatus is configured in a manner to be capable of suitably selecting one or more of these excitation laser light oscillators 211 to be mounted and controlled. In this way, compared to a conventional Er laser treatment device that can only performed treatment with its wavelength fixed at the 2.9 μm band and with limited control (a repeating frequency less than or equal to 100 Hz), the medical laser light source system 10 described above can perform treatment with treatment light having one or more wavelengths that are suitably selected to be optimal from a range from 2.7 μm to 3.2 μm, and with light obtained by adding to the treatment light a portion of the excitation laser light 212 from the excitation laser light oscillator 211 oscillating at a wavelength from 1.5 μm to 2.2 μm.

Furthermore, since the laser oscillation parameters such as the oscillation pulse width, the repeating frequency, the peak power, the oscillation waveform, the laser energy output intensity, and the like can be controlled in a wide range, it is possible to significantly expand the clinical applicability to include external surgery, sterilization, and the like in addition to being used for ablation of teeth and incisions in soft tissue near the teeth ablation performed using a conventional Er pulse laser treatment device, and it is also possible to provide the medical laser light source system 10 that takes maximum advantage of the characteristics of the 2.9 μm band light for each target treatment.

In this way, by evaporating the water included in the dental hard tissue and cutting with the laser oscillated in a 2.9 μm band during dental treatment, compared to mechanically cutting the dental hard tissue with a dental turbine, it is possible to perform painless treatment with no anesthesia or with a minimal amount of anesthesia and without vibration or heat generation. Furthermore, by changing the output, it is possible to use the laser that is pulse-oscillated at the 2.9 μm band not only for treating hard tissue, but also for soft tissue or dental treatment such as dental calculus removing. Furthermore, non-invasive sterilization is performed.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, specification, or diagrams can be performed in any order as long as the order is not indicated by “prior to,” “before,” or the like and as long as the output from a previous process is not used in a later process. Even if the process flow is described using phrases such as “first” or “next” for convenience in the claims, embodiments, or diagrams, it does not necessarily mean that the process must be performed in this order.

### LIST OF REFERENCE NUMERALS

10: medical laser light source system, 20: excitation laser light source apparatus, 210: excitation laser light source unit, 211: excitation laser light oscillator, 212: excitation laser light, 213: focusing unit, 214: light switching switch, 215: solid state laser amplifier, 216: photomixer, 220: cooling unit, 225: spray control unit, 230: power supply unit, 240: control display unit, 241: main controller, 242: display panel, 243: electric terminal, 250: control console, 251: foot switch, 260: first-type light, 261: second-type light, 270: first mixer, 271: second mixer, 272: third mixer, 273: fourth mixer, 280: excitation LD, 281: strong pulse solid state laser oscillator, 290: active fiber, 291: fiber laser, 292: resonator element, 293: resonator element, 294: Q-switch component, 295: WDM coupler, 296: sub controller, 297: fiber laser module, 30: long-distance fiber light guide apparatus, 311: excitation light entrance opening, 312: quartz fiber cord, 313: communication electrical cord, 314: excitation light emission opening, 315A, 315W: tube path, 316: terminals, 320: long-distance fiber (long) light guide apparatus, 321: long-distance fiber (long) side exit terminal, 330: long-distance fiber (short) light guide apparatus, 331: long-distance fiber (short) side entrance terminal, 350: coupler section, 351A, 351W: intra-coupler tube path, 40: miniature 2.9 μm band laser device, 410: laser medium, 411: double reflection prevention film, 412: ferrule, 420: HR mirror, 430: OC mirror, 431: OC film, 432: antireflection film, 440: excitation light focusing unit, 450: relay optical element, 50: treatment table, 500: dental handpiece, 501: laser treatment light, 511A, 511W: outer-cylinder inner-tube path, 520: irradiation tip, 521: tip connection terminal, 522: focusing element, W: spray water, A: spray air

1. A medical laser light source system comprising:
an excitation laser light source apparatus that generates first excitation light having a wavelength greater than or equal to 1.5 μm and less than or equal to 2.2 μm and second excitation light having a wavelength greater than or equal to 1.5 μm and less than or equal to 2.2 μm and differing from the first excitation light with respect to at least one of oscillation energy intensity, oscillation pulse width, repeating frequency, waveform and peak power;
an optical fiber that propagates the first excitation light and the second excitation light generated by the excitation laser light source apparatus; and
a laser device that generates a first laser light having a wavelength greater than or equal to 2.7 μm and less than or equal to 3.2 μm, excited by the first excitation light emitted from the optical fiber, and that generates a second laser light excited by the second excitation light, having a wavelength greater than or equal to 2.7 μm and less than or equal to 3.2 μm wherein at least one of oscillation energy intensity, oscillation pulse width, repeating frequency, oscillation waveform and peak power of the second laser light is different from that of the first laser light,
wherein the laser device is housed in a handpiece arranged at one end of the optical fiber, and
wherein the handpiece is capable of outputting a laser treatment light by mixing the first laser light and the second laser light.

2. (canceled)

3. The medical laser light source system according to claim 1, wherein
the optical fiber includes a quartz fiber that propagates at least one of the first excitation light and the second excitation light.

4. The medical laser light source system according to claim 1, wherein
the excitation laser light source apparatus selectively generates one of the first excitation light and the second excitation light.

5. The medical laser light source system according to claim 1, wherein
the excitation laser light source apparatus includes a light source unit that generates the first excitation light and the second excitation light.

6. The medical laser light source system according to claim 5, wherein
the excitation laser light source apparatus includes a photomixer that mixes together the first excitation light and the second excitation light and propagates the mixture of the first excitation light and the second excitation light in the optical fiber.

7. The medical laser light source system according to claim 1, wherein
the laser device emits laser light that is excited and oscillated by at least one of the first excitation light and the second excitation light, and emits a portion of at least one of the first excitation light and the second excitation light toward outside.

8. The medical laser light source system according to claim 7, wherein
the laser device includes an output mirror that transparently passes at least a portion of at least one of the first excitation light and the second excitation light.

9. The medical laser light source system according to claim 1, comprising:
another optical fiber that is long-distance and propagates the first excitation light and the second excitation light generated by the excitation laser light source apparatus;
another laser device that generates laser light with a wavelength greater than or equal to 2.7 μm and less than or equal to 3.2 μm, using at least one of the first excitation light and the second excitation light emitted from the other optical fiber; and
a light switching switch that propagates at least one of the first excitation light and the second excitation light in at least one of the optical fiber and the other optical fiber.

10. The medical laser light source system according to claim 1, wherein
the excitation laser light source apparatus includes a plurality of laser units that each have a laser oscillating section that generates at least one of the first excitation light and the second excitation light and a sub controller that sets the oscillation energy intensity, the oscillation pulse width, the repeating frequency, the oscillation waveform and the peak power of the laser light generated by the laser oscillating section.

11. The medical laser light source system according to claim 1, wherein
the excitation laser light source apparatus includes a laser medium having a group II-VI semiconductor doped with transitional metal ions.

12. The medical laser light source system according to claim 11, wherein
the transitional metal ions include one of Cr²⁺, Fe²⁺, and Co²⁺, and the group II-VI semiconductor includes one of ZnSe, ZnS, CdSe, and CdTe.

13. (canceled)

14. (canceled)

15. The medical laser light source system according to claim 1, wherein
the excitation laser light source apparatus includes at least one of a solid state laser oscillator performing pulse oscillation and a solid state laser oscillator performing continuous oscillation at an oscillation wavelength greater than or equal to 1.5 μm and less than or equal to 2.2 μm.

16. The medical laser light source system according to claim 15, wherein
the excitation laser light source apparatus includes a solid state laser oscillator that performs pulse oscillation, at an oscillation wavelength greater than or equal to 1.5 μm and less than or equal to 2.2 μm, with an oscillation energy intensity greater than or equal to 0.01 mJ and less than or equal to 2 J, a repeating frequency greater than or equal to 1 Hz and less than or equal to 1 MHz, and an oscillation pulse width greater than or equal to 10 ns and less than or equal to 1000 μs.

17. The medical laser light source system according to claim 1, wherein
the excitation laser light source apparatus includes a MOFA (Master Oscillator Fiber Amplifier) that amplifies a DFB (Distributed FeedBack) laser with a Tm active fiber and is capable of changing the oscillation pulse width within a range greater than or equal to 10 n and less than or equal to 1000 μm, changing the oscillation energy intensity within a range greater than or equal to 0.01 mJ and less than or equal to 2 J, and changing the repeating frequency in a range greater than or equal to 1 Hz and less than or equal to 1 MHz.

18. The medical laser light source system according to claim 1, wherein
the optical fiber includes a quartz fiber with an OH concentration that is less than or equal to 10 ppm.

19. The medical laser light source system according to claim 1, wherein
the optical fiber is connected in a freely attachable and detachable manner to at least one of the excitation laser light source apparatus and the laser device.

20. The medical laser light source system according to claim 1, wherein
the excitation laser light source apparatus further includes a spray control unit that supplies a fluid including at least one of air and water to a tube path adjacent to the laser device.

21. The medical laser light source system according to claim 1, wherein the handpiece is configured to output a part of the first laser light and the second laser light in addition to the laser treatment light.
